(19) United States
(12) Patent Application Publication
(10) Pub. No.: US 2015/0067017 A1
(43) Pub. Date: Mar. 5, 2015

(54) METHOD AND SYSTEM FOR ACCESSING MEDIA

(71) Applicant: QUALCOMM MEMS Technologies, Inc., San Diego, CA (US)

(72) Inventors: Hemang Jayant SHAH, Bangaluru (IN); Siddharth KHIMSARA, San Diego, CA (US); Babak FORUTANPOUR, Carlsbad, CA (US); Shriram GANESH, San Diego, CA (US)

(73) Assignee: QUALCOMM MEMS Techologies, Inc., San Diego, CA (US)

(21) Appl. No.: 14/014,601

(22) Filed: Aug. 30, 2013

(51) Int. Cl. H04L 29/06

(52) U.S. Cl. CPC H04L 65/608
USPC 709/202

(57) ABSTRACT

Methods and systems may facilitate access to media. A mobile computing device may manage media associated with links by evaluating factors that may affect battery life. The mobile computing device may obtain information about the media associated with the links, such as metadata indicating file characteristics, identifying information, and analytics. The information may be included in the media or obtained from a server. The mobile computing device may evaluate factors that affect the device's ability to receive and render the media. Such factors may include the battery charge state, signal strength, connectivity, or media characteristics (e.g., size, complexity, etc.). The mobile computing device may prioritize the links associated with the media based on the evaluation of the factors, such as by sorting the links by rank. The mobile computing device may also hide links, display warnings/indicators, display links in particular manners or formats, and automatically download the media.

### BACKGROUND

Modern cellular data networks and the Internet allow users of mobile computing devices to have virtually unlimited access to media. With the popularity of video and media streaming websites, users can find, share, and consume movies, clips, speeches, albums, and other high-bandwidth media using their smartphones, tablets, laptops, and other computing devices. Users may receive and otherwise access webpages, emails, and other communications that contain links (e.g., hyperlinks, URLs) associated with shared or published media. For example, a friend may send an email including a list of popular YouTube® videos that a recipient should check out using a web browser application on the recipient's tablet computer.

However, accessing links to media without additional information about the media (e.g., runtime, subject matter, hardware requirements, etc.) may present mobile computing device users with various problems. For example, accessing a long video or a video under marginal connectivity conditions when the mobile computing device's battery is nearly depleted may result in the battery quickly running down. As another example, a businessman on a compressed time schedule may access an online video of a conference talk that has a runtime longer than his available time between meetings. As a further example, a user with a restrictive data plan may accidentally exceed his/her data allowance by accessing a video link sent by a friend. With the constant deluge of links to media of unknown lengths, subject matter, and potential drawbacks to viewing devices, users of mobile computing devices could use a solution for determining the links that should be accessed in appropriate and convenient ways.

### SUMMARY

The various embodiments enable a mobile computing device to prioritize and otherwise manage accessing of media associated with links based on an evaluation of factors related to the battery life of the device. The mobile computing device may receive data that includes links to media from various sources, such as data servers and messages (e.g., emails and/or text messages from friends, co-workers, etc.). In response, the mobile computing device may obtain information about the media, such as metadata that describes media file sizes, runtimes, and other characteristics relevant to accessing the media. Additionally, the mobile computing device may evaluate various factors that may affect the device's ability to receive and render the media associated with the links. Such factors may include the battery charge state, the received signal strength, server connectivity, video decoding rate, buffering time, media characteristics (e.g., size, complexity, required technologies, etc.), user preferences, user availability, and other factors that may affect the operation of the mobile computing device. For example, the mobile computing device may evaluate the current battery life of the device in relation to the length of a video associated with a link received in an email to determine whether sufficient battery margin remains to enable the video to be downloaded without fully depleting the battery.

Based on such evaluations of factors related to battery-life, the mobile computing device may prioritize, process, access, and otherwise manage the media associated with the link. In particular, the mobile computing device may determine how and whether to display links to the media, display warnings or other indicators in relation to links and/or the media, and automatically download the media. For example, the mobile computing device may rank links to media within a received message and display the links to the user in an order derived from the ranks. With such evaluations of factors affecting the battery life of the mobile computing device, the end user may have a much smoother and faster experience for enjoying videos, audio files, podcasts, and other media. In an embodiment, a server may be utilized to obtain information (or factors) regarding media associated with links, such as by examining the media contents to determine a runtime. In another embodiment, the server may also be configured to evaluate factors affecting the battery life of the mobile computing device.

### BRIEF DESCRIPTION OF THE DRAWINGS

The accompanying drawings, which are incorporated herein and constitute part of this specification, illustrate exemplary embodiments of the invention, and together with the general description given above and the detailed description given below, serve to explain the features of the invention.

FIG. 1 is a communication system block diagram of a communication network suitable for use with an embodiment.

FIG. 2 is a process flow diagram illustrating an embodiment method for a mobile computing device managing links to media by evaluating battery-life-related factors associated with accessing the media.

FIG. 3A is a process flow diagram illustrating an embodiment method for a mobile computing device managing links to media by evaluating battery-life-related factors associated with accessing the media using metadata associated with the media.

FIGS. 3B and 3D are process flow diagrams illustrating embodiment methods for a mobile computing device managing links to media using information received from a central server.

FIGS. 3C and 3E are process flow diagrams illustrating embodiment methods for a central server to obtain information describing media in response to receiving a request form a mobile computing device.

FIG. 4A is a process flow diagram illustrating an embodiment method for a mobile computing device determining whether to display information associated with media by evaluating battery-life-related factors associated with accessing the media.

FIG. 4B is a process flow diagram illustrating an embodiment method for a mobile computing device determining whether to obtain media by evaluating battery-life-related factors associated with accessing the media.

FIG. 5A is a process flow diagram illustrating an embodiment method for a mobile computing device computing ranks for media by evaluating battery-life-related factors associated with accessing the media.

FIG. 5B is a process flow diagram illustrating an embodiment method for a mobile computing device displaying links associated with media by evaluating battery-life-related factors associated with accessing the media.

FIGS. 6-7C are process flow diagrams illustrating embodiment methods for a mobile computing device evaluating factors related to the ability of the mobile computing device to access media.

FIGS. 8A-8C are diagrams illustrating embodiment emails that include links to media that may be accessed by a mobile computing device.

FIGS. 9A-9B are diagrams illustrating embodiment displays on a mobile computing device that render links to media.

FIG. 10 is a component block diagram of an example laptop computing device suitable for use with the various aspects.

FIG. 11 is a component block diagram of a smartphone-style mobile computing device suitable for use in an embodiment.

FIG. 12 is a component block diagram of a server device suitable for use in an embodiment.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The word “exemplary” is used herein to mean “serving as an example, instance, or illustration.” Any implementation described herein as “exemplary” is not necessarily to be construed as preferred or advantageous over other implementations.

The term “mobile computing device” is used herein to refer to any one or all of cellular telephones, smart-phones (e.g., iPhone®), web-pads, tablet computers, Internet enabled cellular telephones, WiFi enabled electronic devices, personal data assistants (PDA's), laptop computers, personal computers, and similar electronic devices equipped with at least a wide area network connection (e.g., an LTE, 3G or 4G wireless wide area network transceiver or a wired connection to the Internet). In various embodiments, mobile computing devices may also include a GPS receiver, chip, circuitry, module, or other components for communicating with GPS satellites.

The various embodiments provide methods for mobile computing devices to evaluate battery-life-related factors related to media associated with links received in messages, and prioritize or otherwise present information that enables users to make informed decisions regarding accessing the media. Links to media may be received by mobile computing devices within various data communications, such as emails, webpages (e.g., HTML), and other files (e.g., pdf documents). For example, a smartphone mobile computing device may receive an email that includes a set of hyperlinks or URLs to funny videos streamed via a content website. The mobile computing device may pre-filter, prioritize, and otherwise evaluate such links to media based on how receiving and rendering such media may impact the operations of the mobile computing device, with particular emphasis on the battery state of the device. Based on such evaluations, the mobile computing device may present the links in a manner that enables users to appreciate how accessing the related media may affect the battery state of the device.

The mobile computing device may identify and utilize various descriptive information or factors about the media and/or links to the media to determine how accessing the media may affect the device's battery life. In particular, the mobile computing device may obtain metadata, codes, or other informative information embedded within or transmitted in conjunction with the links associated with the media. For example, metadata may be associated with a link to a streaming video indicated within an email. Such obtained information may directly indicate important characteristics of the related media, such as file size, run time, etc. For example, a smartphone accessing HTML code of a webpage may obtain metadata associated with a media link regarding the media's runtime, type of data, technology used for rendering the media, the subject matter, the identity of the user who created or posted the media, and other attributes of the content. In an embodiment, a central server, such as a proxy server, may obtain and/or deliver such metadata or other descriptive information to the mobile computing device. For example, when metadata is not transmitted along with a link included in a webpage, the central server may be configured to access the media and generate metadata describing the media that may be used by the mobile computing device. In another embodiment, the mobile computing device may also access online data sources to obtain information regarding media identified in a link, such as a server hosting the link and/or servers hosting reviews of media, in order to obtain further information regarding the media. For example, the mobile computing device may obtain subject matter type or rating data from a server of a rating agency or the media host server.

The mobile computing device may evaluate identified factors that may affect the battery (or battery-life-related factors) when downloading and/or rendering the media. Various factors that may be evaluated by the mobile computing device may include: battery charge state (e.g., remaining battery life); factors affecting an amount of battery life needed to receive the media, such as the strength of a wireless signal to be used to receive the media, the quality of a connection to a server that hosts the media, the speed of the connection to the server that hosts the media, the availability of the server that hosts the media, the size of the media file, the response time of the server that hosts the media, the size of the media file, an estimated download time for the media file; and factors affecting an amount of battery life needed to render the media, such as the type of media file (e.g., text may require less power to render than video), the complexity of the media data (e.g., some codecs may require more power to render than other codecs), the runtime of the media file, the size of the media file; and/or other factors.

Other factors that may be evaluated may include states, conditions, configurations, and capabilities of the mobile computing device, such as current battery level, current wireless link conditions, applications in use, and applications installed. Other factors may also include the user's location, activities, and schedule. In an embodiment, the mobile computing device may query databases (e.g., the user's calendar), a GPS sensor, state information, battery level, accelerometers and other sensors, and other information sources available to the device processor that may store information relevant to the mobile computing device and user states. User state information may also include user preferences which a user may store in memory. Such user preferences may be time of day, day of week, and/or location dependent.

In an embodiment, the mobile computing device implementing the embodiment methods may evaluate various factors related to accessing media information and/or the capabilities of the device (e.g., device operating states, etc.) in order to calculate a rank, priority, importance, filter decision (e.g., download/don't download) and/or emphasis for each received media link. For example, the mobile computing device may rank a first video associated with a YouTube® link as a low priority and a second video associated with a professional conference link as a high priority for the particular user of the mobile computing device based on the length and subject matter of the video informed by the mobile computing device's battery level, the quality of the wireless link, user preferences, the user's location, schedule and/or current activity level (e.g., moving or still). The mobile computing device may utilize various factors, rule sets, conditions, variables, user preferences, and other settings to calculate this ranking of media associated with received links. In an embodiment, the mobile computing device may perform a heuristics algorithm that evaluates various factors separately and/or in combination with metadata of links, user preferences, and other information related to the mobile computing device to calculate ranks.

In an embodiment, the mobile computing device may determine a rank/appropriateness of a link (or the media associated with the link) by evaluating the various sources of information listed above, applying an algorithm or weighting factors to arrive at a decision or recommendation. The weight or importance of each of the factors may also depend upon the state or value of the factor. For example, the amount of remaining battery life of the mobile computing device may be an ultimate concern in calculating the rank of a link when the battery charge state drops below a minimum threshold. Thus, in such an example, if the battery level drops below a certain threshold (e.g., below 20% remaining charge), all media may be blocked until the device is plugged into a charger, regardless of the other factors. In various embodiments, the ranks of multiple links may be calculated based on such factors as well as based on relative ranks between other available media links.

In an embodiment, once various factors are evaluated, the mobile computing device may prioritize, present or hide the links on the user interface display based on the evaluations. For example, the mobile computing device may present a list of all links within a received email ordered from highest to lowest rank. As another example, the mobile computing device may render an email including graphical indicators, such as color codes, highlights, and/or circles, that represent the rank of the related links. In other words, the mobile computing device may sort, render, display, hide/ignore, and present media links based on the evaluation of battery-life-related factors. With such a presentation, the mobile computing device may show the user information to enable a user experience optimized for the user's interests/time and the technical limitations of the mobile computing device. In another embodiment, the mobile computing device may also be configured to automatically act in response to the evaluations of battery-life-related factors, such as automatically downloading highly ranked links under certain conditions. For example, the mobile computing device may download media when plugged into a power supply or just before a user's calendar indicates a period of free time.

In an embodiment, the mobile computing device may be configured to render ranking, recommendations, conclusions, and metadata for use by the user, such as by rendering runtime information of a video when a mouse cursor (or the user's finger) hovers over and/or selects a link. The mobile computing device may also render warning messages or suggestion messages that offer recommended actions based on the metadata and/or ranks associated with links. For example, the mobile computing device may render a pop-up dialog box that warns when a video would require more battery life than currently available, when streaming the video needs more data than is available with the user's mobile plan, and/or when the related video contains “not safe for work” material inappropriate for viewing in the mobile computing device's current location. In another embodiment, the mobile computing device may not present information related to a media link when its calculated rank or other characteristics of the link do not satisfy predefined conditions. For example, based on user preferences, the mobile computing device may not render any information related to a link to a video when viewing that video would be too expensive in a current data plan.

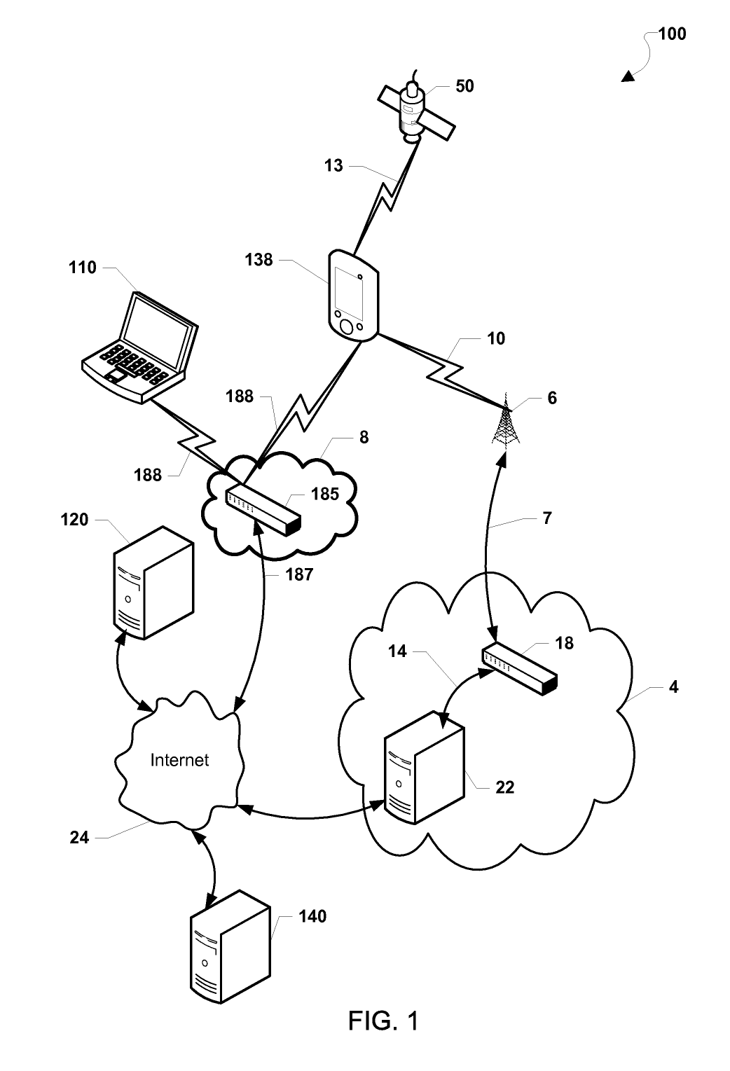

FIG. 1 illustrates a communication network 100 suitable for use with the various embodiments. The communication network 100 may include a smartphone mobile computing device 138 that utilizes a long-range radio or wireless transceiver to exchanging data with a cellular tower 6 via a long-range data link 10. For example, the smartphone mobile computing device 138 may be equipped with a cellular network modem and an antenna capable of transmitting data transmissions to a 3G, 4G or LTE cellular network. In an embodiment, the long-range (or high-power) data link 10 may require increased power consumption compared to short-range wireless data links (e.g., Bluetooth, Zigbee, etc.), and so the smartphone mobile computing device 138 may selectively use the long-range radio to conserve battery power. In an embodiment, data may be received from the cellular tower 6, such as cell site identification information, general location information, and other data relevant to the cellular network associated with the cellular tower 6.

In an embodiment, the smartphone mobile computing device 138 may also include a global positioning system (GPS) chip (or a GPS sensor) and receive transmissions from a GPS satellite 50 via a satellite data link 13. For example, the smartphone mobile computing device 138 may receive GPS coordinates (or GPS fix data), along with timestamp information, via the satellite data link 13 when the GPS satellite 50 is in orbit over the smartphone mobile computing device 138.

The smartphone mobile computing device 138 may also transmit wireless signals to a wireless router 185 via a wireless data link 188. The wireless router 185 may be associated with a local area network 8 and may provide a connection 187 to the Internet 24. The wireless signals via the wireless data link 188 may be WiFi transmissions transmitted by the smartphone mobile computing device 138 via a WiFi transceiver. In an embodiment, a laptop mobile computing device 110 may also transmit wireless signals using a wireless transceiver to the wireless router 185 via the wireless data link 188, and may thus communicate with other devices over the Internet 24.

In various embodiments, the mobile computing devices 110, 138 may utilize the data links 10, 188 (e.g., long-range radio data link to a cellular network or local area network 8) to download or otherwise receive data from primary data sources, such as a web server, a hosting server, or a cloud storage server. For example, an application (or app) executing on the smartphone mobile computing device 138 may initiate a download of data from a remote data server 140 via the long-range data link 10. As another example, the laptop mobile computing device 110 may utilize the wireless data link 188 to receive streaming video data, emails, and other data from the data server 140. Primary data sources, such as the data server 140, may be third-party devices associated with services that provide useful data, such as streaming media (e.g., videos, music, podcasts, etc.), weather reports and/or music information.

In an embodiment, the smartphone mobile computing device 138 may establish communications with a data network 4 via a data link 7 from the cellular tower 6. For example, the smartphone mobile computing device 138 may transmit data through the cellular tower 6 to a cellular telephone system. The data network 4 may include switching centers 18 that are coupled in network connections 14 to Internet gateway servers 22 to enable data connections to the Internet 24. The data network 4 may also enable telephone calls to be made to mobile computing devices, such as smartphones, tablet devices, and feature phones. For example, a smartphone mobile computing device 138 may exchange phone calls and/or SMS text messages with the cellular tower 6 via the long-range data link 10. In an embodiment, the data network 4 may also communicate data, telephone calls, and other information to landline telephones (not shown).

Through the various connections to the Internet 24, the mobile computing devices 110, 138 may transmit communications, such as website data requests, database queries, and download/upload transmissions, to primary data sources (i.e., the remote data server 140) or a central server 120. In an embodiment, the central server 120 may act as a computing device that stores and/or processes data related to the smartphone mobile computing device 138 and/or the laptop mobile computing device 110. In particular, the central server 120 may receive messages from the mobile computing devices 110, 138 that include links to media that the central server 120 may investigate. In particular, and as described below, the central server 120 may exchange communications via the Internet 24 with various data servers 140 that maintain media indicated within such messages from the mobile computing devices 110, 138. The central server 120 may be configured to download media from these data server 140 and evaluate the media to obtain informative data, such as runtimes of videos, tagging information, file size, file complexity, and other characteristics of the media that may be useful factors for the mobile computing devices 110, 138 to evaluate.

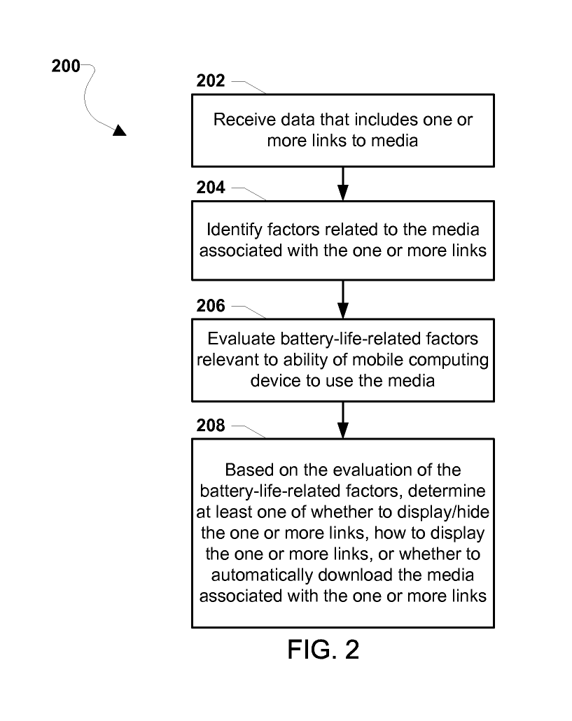

FIG. 2 illustrates an embodiment method 200 for a mobile computing device to manage media links by evaluating factors associated with accessing the media. As described above, the mobile computing device may determine how to present links associated with media to provide users with information indicating how the mobile computing device, and its battery, may be affected by accessing the media. In other words, the mobile computing device may evaluate battery-life-related factors to present information for consuming media in a battery-conscious manner. In block 202, the mobile computing device may receive data that includes one or more links to media. For example, the mobile computing device may receive a document, an email, SMS text message, or other message type that includes a URL or hyperlink (e.g., ‘http://domain/,’ etc.) to a video streamed or hosted by a video service, such as Hulu®, Vimeo®, or YouTube®. Alternatively, the mobile computing device may receive data that is HTML code, such as a webpage document. For example, the mobile computing device may receive webpage data via a browser application.

In block 204, the mobile computing device may identify factors related to the media associated with the one or more links. For example, from the received data the mobile computing device may obtain metadata information that indicates the duration or runtime of a video associated with a link. The identified factors or information may include various characteristics, attributes, and other descriptive information about the media associated with the links, such as technology required for rendering the media (e.g., codecs), the size of the media, the resolution of the media (e.g., bitrate, HD vs. SD, etc.), the number of views a video has received by various Internet users, indicators of popular sections within the media (e.g., parts where people have watched), indications of sections within the media where users have stopped rendering/receiving the media (e.g., notifications indicating viewers stop watching after a certain number of minutes, etc), and tags that indicate descriptions of the media (e.g., date of creation, creator of the media, media class type, subject matter, “not safe for work” warnings, etc.). In various embodiments, the mobile computing device may obtain the factors or information about the media from header information, metadata, or other indicators embedded within the received data, as described below. In another embodiment, the mobile computing device may identify or otherwise obtain such information or factors about the media from a central server, such as described below.

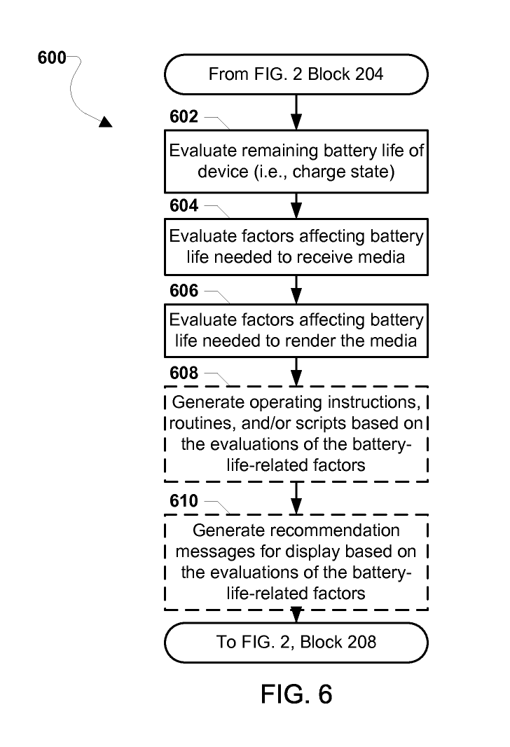

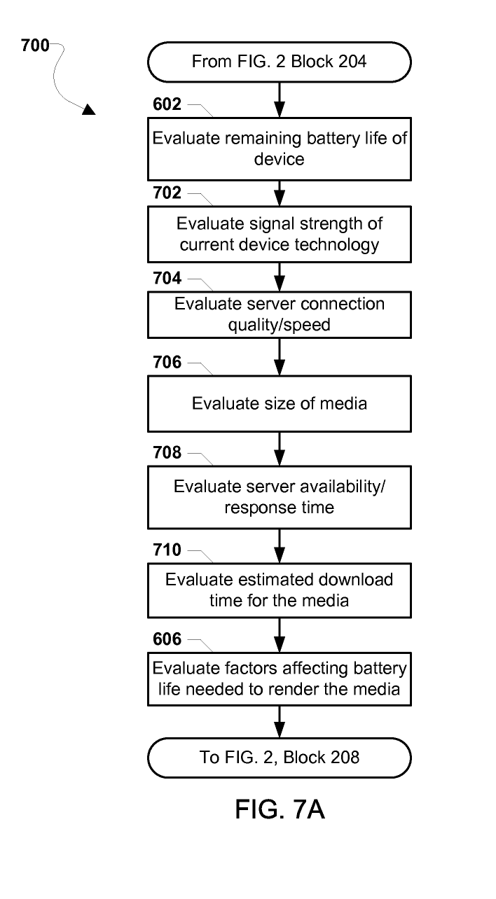

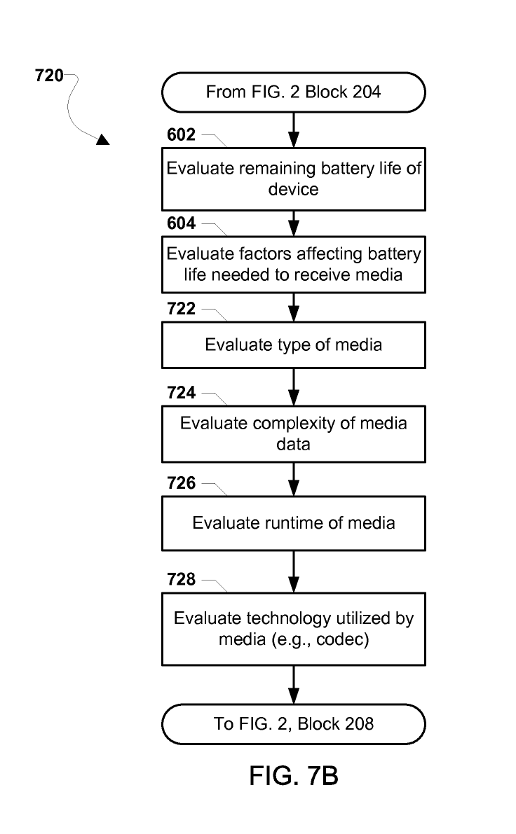

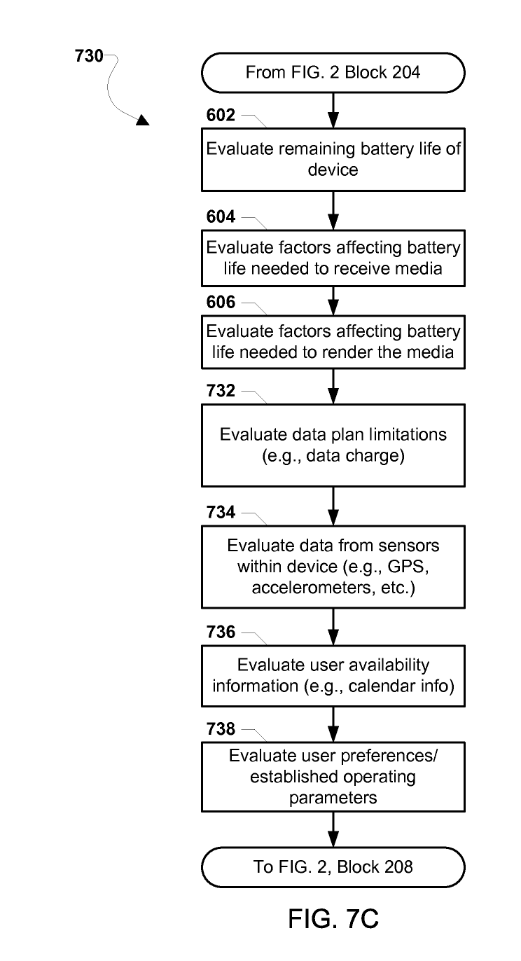

In block 206, the mobile computing device may evaluate battery-life-related factors relevant to the ability of the mobile computing device to use the media, such as media runtimes and server connectivity required to download the media. For example, the mobile computing device may perform analysis operations to assess the current battery life in relation to the amount of power required to download and/or render a video. Battery-life-related factors may be any information about the media, the mobile computing device's ability to receive the media, and/or the mobile computing device's ability to render the media. Battery-life-related factors may be obtained or informed by the operations of block 204. The evaluation of various factors is described below with reference to the operations in FIGS. 6-7C.

In block 208, based on the evaluation of battery-life-related factors, the mobile computing device may determine at least one of whether to display or hide the one or more links, how to display the one or more links, or whether to automatically download the media associated with the one or more links. In other words, the mobile computing device may determine how to utilize the links based on the evaluated factors. For example, the mobile computing device may use the links to automatically download and render a podcast, movie, song, or other media when the mobile computing device's battery and data plan can support such activities. As another example, the mobile computing device may display the links in an order or format based on the device's ability to render the associated media given the current battery life. As yet another example, the mobile computing device may hide a certain link to a video when the factors indicate the mobile computing device does not have adequate battery life to render the entire video.

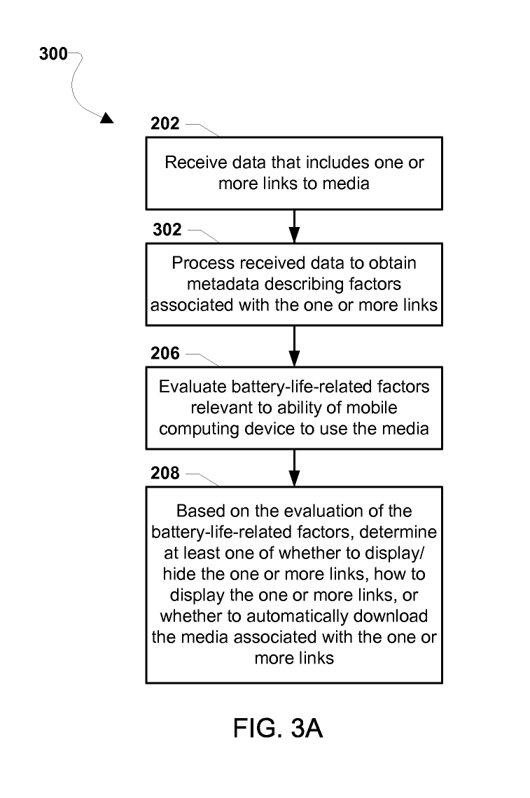

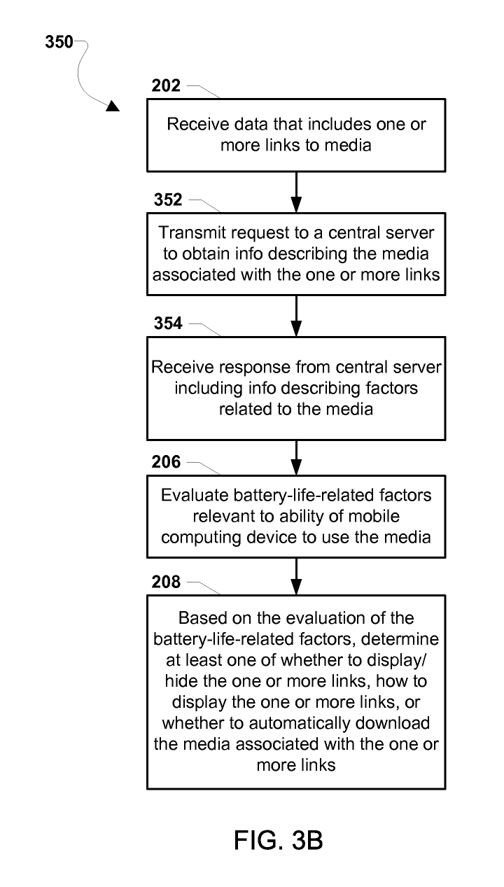

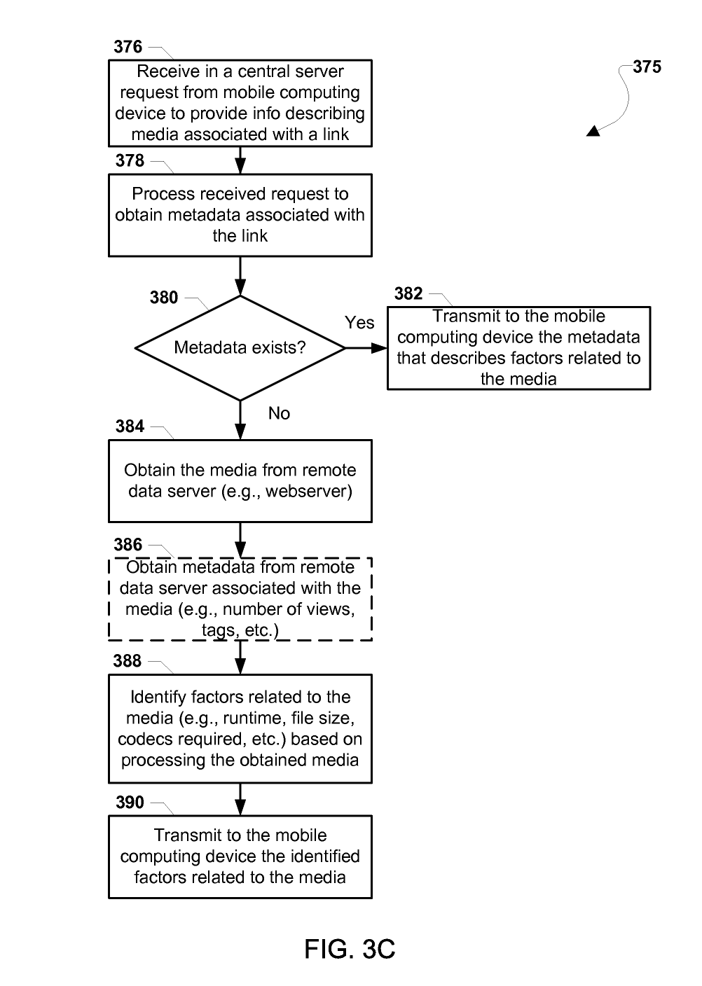

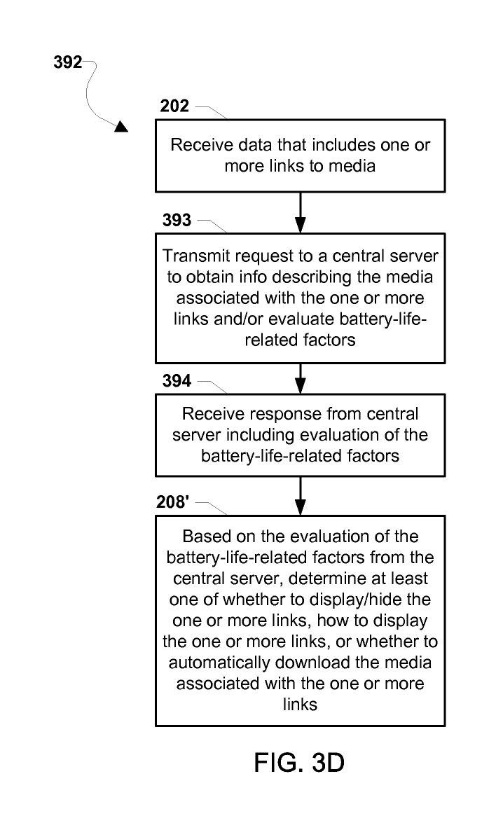

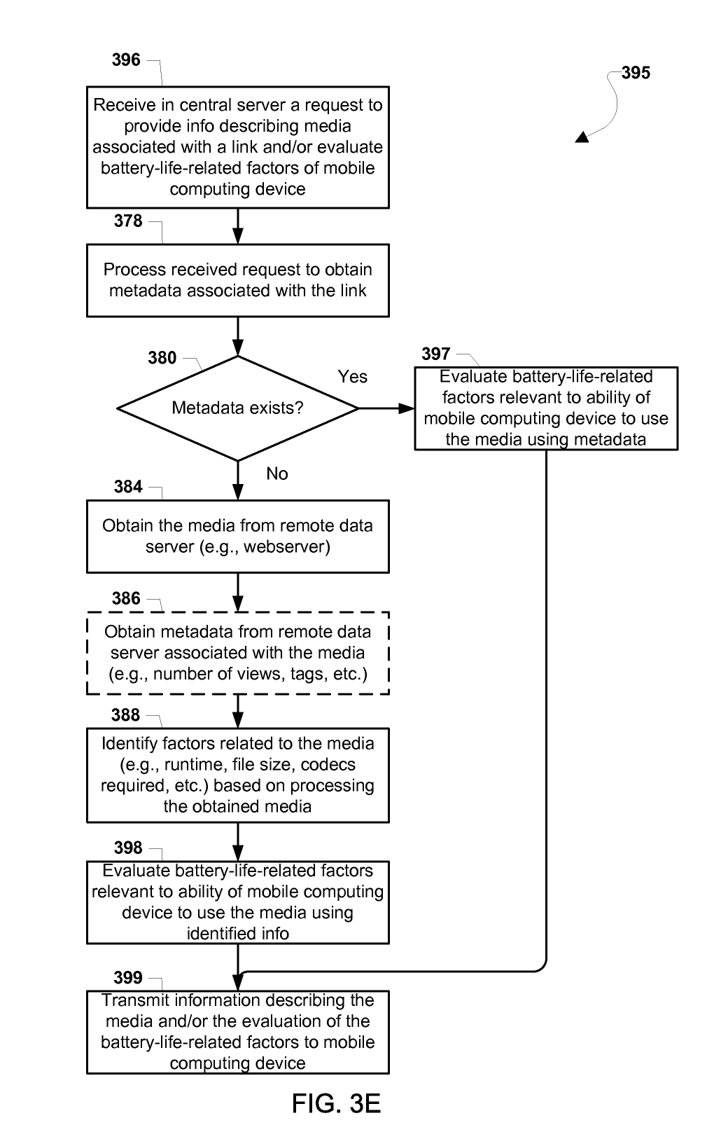

FIG. 3A illustrates an embodiment method 300 for a mobile computing device to manage media links by evaluating factors associated with accessing the media using metadata. The method 300 is similar to the method 200 described above, except the method 300 includes operations to utilize metadata received within data or a message. In particular, using certain formatting, syntax, and other messaging protocols, data and/or messages may include headers, codes, tags, flags, and other information that describes media associated with links included within the data/messages. For example, an HTML webpage that includes a hyperlink to a YouTube® video may also be encoded with metadata that indicates the YouTube® video's runtime, classification, and creator. With such embedded information, the mobile computing device may be able to determine whether and/or how the mobile computing device may process the media associated with the link.

In block 202, the mobile computing device may receive data that includes one or more links to media, such as a webpage, an email, or other document with at least one embedded hyperlink to YouTube® videos. In block 302, the mobile computing device may process the received data to obtain metadata describing factors associated with the one or more links, such as battery-life-related factors. The mobile computing device may parse, analyze, and interpret code, header information, indicators, and other flags within the received data (e.g., email message, HTML code, etc.). For example, HTML in a received email document may include metadata flags or indicators that report a video's runtime (e.g., a few minutes, etc.) and that precede a URL for the video. In another embodiment, the mobile computing device may identify metadata within the links or URL associated with the media. For example, the mobile computing device may evaluate the text of a hyperlink to identify appended information describing the media that may be accessed at the address within the hyperlink. In other words, metadata may be numbers, phrases, codes, and/or other flags embedded within the links.

In block 206, the mobile computing device may evaluate battery-life-related factors relevant to the ability of the mobile computing device to use the media. For example, the mobile computing device may compare a video runtime indicated by metadata to the current battery life and a signal strength to evaluate the power charge of rendering and receiving the video. In block 208, based on the evaluation of battery-life-related factors, the mobile computing device may determine at least one of whether to display or hide the one or more links, how to display the one or more links, or whether to automatically download the media associated with the one or more links.

FIG. 3B illustrates an embodiment method 350 for a mobile computing device to manage media links by evaluating factors associated with accessing the media using information received from a central server. The method 350 is similar to the method 200 described above, except that the mobile computing device may receive information describing media from a trusted server instead of obtaining such information itself. The central server may be a trusted source, and may be any server or computing device that the mobile computing device has established as a proxy for investigating links to media. In various embodiments, the central server may be an intermediary device that processes, evaluates, and otherwise obtains information to improve the operations of mobile computing devices. For example, the central server may be a device that stores, updates, and generates information about the characteristics of various media that may be downloaded or otherwise accessed by subscribers (e.g., the mobile computing device).

In block 202, the mobile computing device may receive data that includes one or more links to media. In block 352, the mobile computing device may transmit a request to a central server to obtain information describing the media associated with the one or more links. In other words, when the received data does not include information (e.g., metadata) that describes the characteristics/factors related to the media associated with the links or when the mobile computing device is not configured to obtain such information, the central server may be contacted to provide information describing the media. For example, the mobile computing device may receive an email that merely indicates a URL associated with a video without including additional information regarding the runtime, topic, or author of the video. Transmitting a request message to the central server may benefit the mobile computing device by causing the information to be obtained remotely, thus allowing the mobile computing device to avoid expending battery power, time, data plan usage, and other assets to obtain the information about the media and/or link needed to determine how or whether to process the media.

In block 354, the mobile computing device may receive a response from the central server including information describing factors related to the media, such as the media associated with the one or more links. For example, the response may be a message that includes metadata that describes the runtime, required codecs, data complexity, and other important characteristics of the media. In various embodiments, the response may include codes and other information formatted for use by a particular application (or “app”) executing on the mobile computing device. For example, the mobile computing device may execute a background process, service, or management app that receives messages from the central server on a periodic basis. In block 206, the mobile computing device may evaluate battery-life-related factors relevant to the ability of the mobile computing device to use the media, such as by performing an analysis algorithm on the information received in the response from the central server. In block 208, based on the evaluation of battery-life-related factors, the mobile computing device may determine at least one of whether to display or hide the one or more links, how to display the one or more links, or whether to automatically download the media associated with the one or more links.

FIG. 3C illustrates an embodiment method 375 for a central server to transmit information describing media in response to receiving requests from a mobile computing device. As indicated above, the mobile computing device may have limited bandwidth, processing cycles, Internet connectivity, and/or data plan use availability. Therefore, the central server may be utilized to investigate media associated with links received by the mobile computing device. In other words, the central server may be employed by the mobile computing device to obtain metadata, header information, and/or any other information from various sources that indicate the characteristics of the media such that a determination may be made as to how or whether the mobile computing device may process that media. In various embodiments, the method 375 may be performed by the central server in combination with the mobile computing device performing operations of the method 350 described above with reference to FIG. 3B.

In block 376, the central server may receive a request from a mobile computing device to provide information describing media associated with a link. For example, the central server may receive a transmission with a code that indicates an included link to media should be investigated by the central server. In block 378, the central server may process the received request to obtain metadata associated with the link. The operations of block 378 may be similar to those performed by the mobile computing device as described above with reference to the operations in block 302 of FIG. 3A. For example, the central server may parse the link from the received request message to identify codes, bits, flags, or other information that may be embedded within the link. In determination block 380, the central server may determine whether metadata exists, such as metadata appended to the link received from the mobile computing device. For example, the central server may determine no metadata exists when the link is merely a web address (e.g., URL) of a video. If metadata exists (i.e., determination block 380=“Yes”), in block 382 the central server may transmit to the mobile computing device the metadata that describes factors related to the media. For example, the central server may transmit a message with information that indicates the runtime and quality of a video.

If metadata does not exist (i.e., determination block 380=“No”), in block 384 the central server may obtain the media from a remote data server, such as a web server. The central server may download, stream, or otherwise retrieve the media associated with the link. For example, the central server may perform actions to access a video that is hosted on a remote streaming device. In optional block 386, the central server may obtain metadata from the remote data server. In addition or instead of obtaining the actual media via a download, etc., the central server may obtain metadata, header information, summary reports, or other informative data from the data server that may indicate the characteristics of the media associated with the link. For example, the central server may exchange messages with the remote data server to obtain tags, codes, and data that indicates the number of views, the subject matter, an identifier of the posting user, the runtime, and other analytics information about a certain video.

In block 388, the central server may identify factors related to the media based on processing the obtained media. For example, the central server may determine the runtime, file size, and required codecs for a video media file based on the central server actually downloading and/or rendering the video. In various embodiments, the information describing the video may be identified by the central server performing analytical operations on the obtained video, such as sampling and analyzing sections of the media, compression evaluations, and embedded data processing. In an embodiment, the central server may generate metadata, codes, or other indicators that describe the characteristics/factors associated with the media. In other words, the central server may determine characteristics of the media while rendering and analyzing the media. In block 390, the central server may transmit to the mobile computing device the identified factors related to the media. For example, the central server may transmit a message that includes metadata describing video runtime information that the central server generated in response to downloading a media file.

In an embodiment, the central server may perform the operations of the method 375 without receiving a request from the mobile computing device. For example, the central server may be configured to receive all messages, correspondences, and other transmissions directed to the mobile computing device, and may automatically obtain information describing any links and/or media within such messages. In other words, the central server may be established as a pre-processing device for the incoming messages of the mobile computing device.

FIG. 3D illustrates an embodiment method 392 for a mobile computing device to receive an evaluation of battery-life-related factors from a central server. The method 392 may be similar to the method 350 described above with reference to FIG. 3B, except that the mobile computing device may request that the central server perform operations to determine whether or how media associated with a link may be processed by the mobile computing device. In other words, when in receipt of links to media, the mobile computing device may determine how to utilize (e.g., display) the media based on evaluation information provided by the central server. For example, the mobile computing device may receive from the central server the rank, priority, or sorting order of links.

In block 202, the mobile computing device may receive data that includes one or more links to media. In block 393, the mobile computing device may transmit a request to a central server to obtain information describing the media associated with the one or more links and/or to evaluate battery-life-related factors. The request may include the link and a code or other indicator known to the central server that indicates the mobile computing device requires additional information to further process the media and/or the links. The battery-life-related factors may be as described below, such as signal strength information, battery charge, and various other data, conditions, and/or capabilities of the mobile computing device. For example, the request may include the current battery charge state of the mobile computing device (e.g., half power remaining, plugged into a wall outlet, etc.), specifics about the data plan of the mobile computing device (e.g., there is only a small amount of data left on the device's total monthly data allowance, etc.), sensor data (e.g., GPS coordinates, accelerometer sensor data, etc.), and any user preferences or settings that may related to receiving and/or rendering media (e.g., the user has indicated a high priority for any media from a particular content creator on Vimeo®, etc.).

In block 394, the mobile computing device may receive a response from the central server including an evaluation of battery-life-related factors. Such an evaluation may include a conclusion indicating the ability of the mobile computing device being able to receive and/or render the media based on the factors and any information (e.g., metadata) available that describes the characteristics of the media. For example, the evaluation may indicate that the mobile computing device should not immediately begin streaming a video stream associated with a certain link, as the video will require more battery charge than is currently available to the mobile computing device. In an embodiment, the response may include a recommendation, rankings, instructions, software, code, and/or other information that may be utilized by the mobile computing device to begin downloading media associated with the links and/or to display the links. In block 208′, based on the evaluation of battery-life-related factors from the central server, the mobile computing device may determine at least one of whether to display or hide the one or more links, how to display the one or more links, or whether to automatically download the media associated with the one or more links.

In an embodiment, the mobile computing device may be configured to periodically transmit battery-life-related factors, characteristics, and conditions to the central server, regardless of whether links to media have been received by the mobile computing device. For example, the mobile computing device may perform a background service, routine, or operation that periodically sends updates, statistics, states, and activity reports to the central server as part of a general diagnostics and/or tracking service.

FIG. 3E illustrates an embodiment method 395 for a central server to evaluate battery-life-related factors in response to receiving a request from a mobile computing device. The method 395 is similar to the method 375 described above with reference to FIG. 3C, except the method 395 includes operations for evaluating factors relevant for enabling the mobile computing device to further manage media associated with a link. In response to receiving a request, the central server may be configured to return a message that provides sufficient information for the mobile computing device to process the media, display links, and otherwise act upon a receiving media links. In various embodiments, the method 395 may be performed by the central server in combination with the mobile computing device performing the operations of the method 392 as described above with reference to FIG. 3D.

In block 396, the central server may receive a request to provide information describing media associated with a link and/or evaluate battery-life-related factors of a mobile computing device. The request may include the link and various data describing the conditions, capabilities (e.g., hardware, installed software/services, etc.) of the mobile computing device. In an embodiment, the request may include an identifier of the mobile computing device that the central server may use to perform a lookup in a database of mobile computing devices. In particular, the identifier may be a key in a database to retrieve battery-life-related factors, characteristics, and/or other information regarding the mobile computing device that may be needed to evaluate whether the mobile computing device may receive and/or render the media. For example, when the mobile computing device is configured to periodically upload status information to the central server for storage, the central server may retrieve battery-life-related factors from such storage. In other words, the request may or may not include the actual battery-life-related factors based on whether the mobile computing device has previously uploaded that information to the central server as part of a periodic status update.

In block 378, the central server may process the received request to obtain metadata associated with the link. In determination block 380, the central server may determine whether the metadata exists. If the metadata does exist (i.e., determination block 380=“Yes”), in block 397 the central server may evaluate battery-life-related factors relevant to the ability of the mobile computing device to use the media using the metadata. For example, the central server may evaluate whether the mobile computing device may successfully download a file or a certain size without exceeding its data plan limits and without unacceptably depleting its battery life. If the metadata does not exist (i.e., determination block 380=“No”), in block 384 the central server may obtain the media from a remote data server. In optional block 386, the central server may obtain metadata from the remote data server associated with the media, such as tagging information that indicates the category of media, the size of the file, and/or the audience rating of the media. In block 388, the central server may identify factors related to the media based on processing the obtained media.

In block 398, the central server may evaluate battery-life-related factors relevant to the ability of the mobile computing device to use the media using the identified information. For example, the central server may compare signal strength information provided by the mobile computing device with suggested playback settings from the data server to determine whether the mobile computing device should view the related video now or within a few minutes. In block 399, the central server may transmit information describing the media and/or the evaluation of battery-life-related factors to the mobile computing device. For example, the information may include any metadata obtained from remote data servers as well as recommendations, suggestions, rankings, and instructions for the mobile computing device to perform to further process the media.

In various embodiments, the central server may be configured to perform operations similar to those described below with reference to FIGS. 6-7C to evaluate battery-life-related factors. For example, during the operations in block 397 or block 398, the central server may be configured to perform operations of method 730 described below with reference to FIG. 7C to evaluate whether the mobile computing device may receive and render a video file while a user is in between meetings.

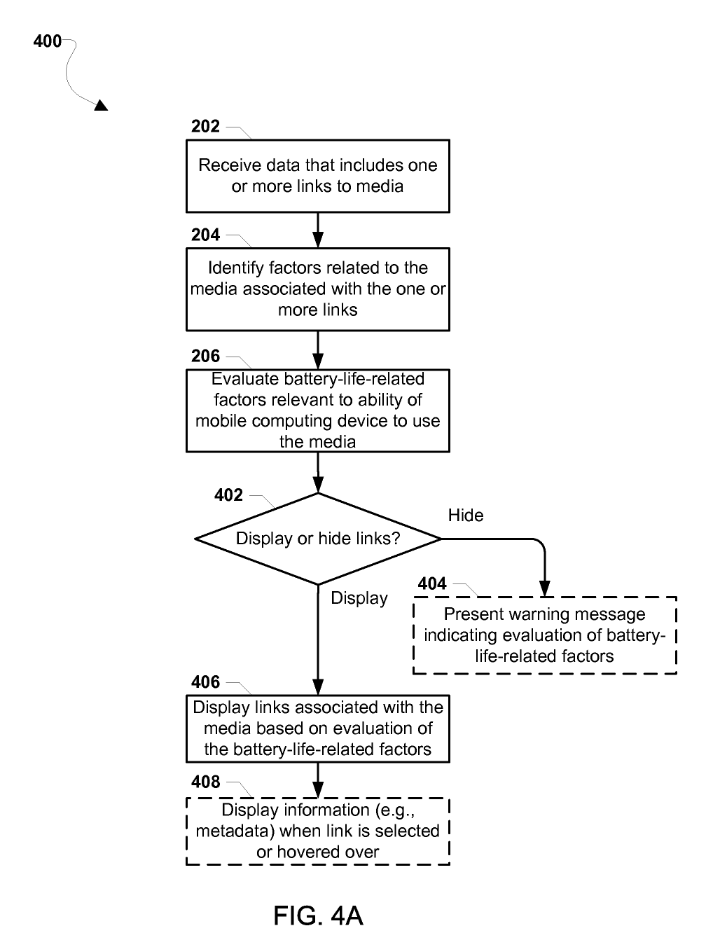

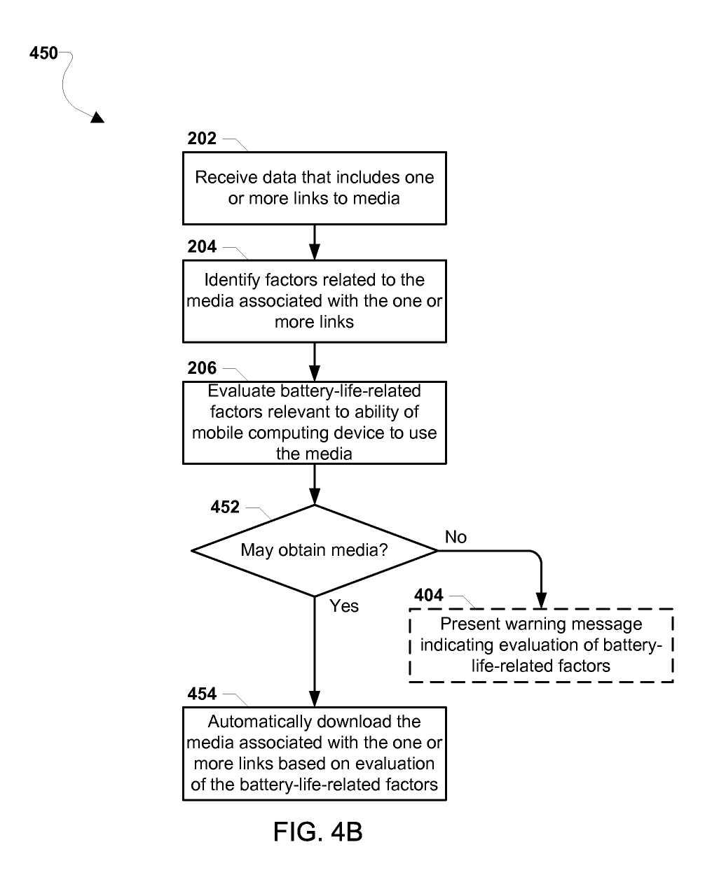

FIG. 4A illustrates an embodiment method 400 for a mobile computing device to determine whether to display information associated with media by evaluating factors associated with accessing the media. As described above, the mobile computing device may manage media associated with links received in data (e.g., emails from friends including hyperlinks to interesting YouTube® videos, webpages loaded via a browser application, etc.). In particular, the mobile computing device may be configured to display links in various ways based on the evaluation of battery-life-related factors relevant to receiving and/or rendering the media. For example, when plugged into a wall outlet, the mobile computing device may determine that all links to media may be presented to the user of the device, as power needed to render the videos is readily available. As another example, the mobile computing device, such as a smartphone, may determine that links to videos may be displayed with color-coded graphics to indicate to the user of the device that some links are not recommended for current viewing, while others are suggested to be watched immediately.

In block 202, the mobile computing device may receive data that includes one or more links to media. In block 204, the mobile computing device may identify factors related to the media associated with the one or more links, such as by obtaining runtime information about a video. In block 206, the mobile computing device may evaluate battery-life-related factors relevant to the ability of the mobile computing device to use the media. In determination block 402, the mobile computing device may determine whether it may display or hide the links for the media. For example, based on the evaluation operations in block 206, the mobile computing device may determine that there is not sufficient battery charge for the mobile computing device to view the media without shutting down in the middle of a stream, and therefore the link to the media should not be shown (e.g., deactivate, grey-out, or hide the hyperlink). In an embodiment, the mobile computing device may be configured to display all links, regardless of the evaluation of battery-life-related factors, or alternatively, may only display those links to media that may be received and/or rendered within predefined tolerances. For example, while at a workplace location based on GPS coordinates, the mobile computing device may be configured to only display links of videos that are safe for viewing at work and that the device has sufficient battery charge to render completely.

If the mobile device determines that it should hide the links (i.e., determination block 402=“Hide”), in optional block 404 the mobile computing device may present a warning message on a user interface display indicating the evaluation of battery-life-related factors. In other words, instead of displaying the link to the media, the mobile computing device may display a message, dialog box, graphic, symbol, or other information that describes why a link is not presented to the user of the device. For example, when the mobile computing device determines that a link to the media should not be displayed based on a poor signal strength that would make viewing the media unpleasant, the mobile computing device may render warning text that states, “The webpage includes a link to a video that may not be watched now due to poor signal strength. Please refresh later.” However, if the mobile device determines that the links may be displayed (i.e., determination block 402=“Display”), in block 406, the mobile computing device may display the links associated with the media based on the evaluation of battery-life-related factors. The manner of displaying, rendering, or otherwise presenting the links may be determined by the evaluation of battery-life-related factors performed in block 206. For example, when the mobile computing device determines the media associated with the links is too long to watch based on an evaluation of metadata of the media and the device's current battery charge, the links may be displayed in colors that indicate the media are not currently recommended (e.g., the links may be highlighted in a red color).

In various embodiments, the links may be presented on a user interface display with particular color-codings, symbols, indicators, warnings, and other information that may indicate to the user any limitations, priorities/ranks, or other considerations regarding the receipt and/or rendering of the associated media. For example, as described below, a link may be displayed with a color that corresponds to a high-ranking video that is recommended to be watched while operating in a low-power mode.

In optional block 408, the mobile computing device may display information when a link is selected or hovered over. The information may be warnings or indicators that are based on the evaluation of battery-life-related factors performed in block 206. For example, when a user input is detected that corresponds to a certain link (e.g., a mouse click on the link, a touch input on a touchscreen, etc.), the mobile computing device may display a warning pop-up box that indicates the media associated with the link is not recommended for viewing based on the length of the media and the current battery life. As another example, when the mobile computing device determines that a cursor is hovering over the link, the device may render blinking text that states something like: “The signal strength is great, the video is short, you have time in between your meetings, and the battery has plenty of power. Go ahead, watch now!” In another embodiment, the information displayed in response to a selection or hover may include the metadata associated with the link. For example, a pop-up box including the duration of a video may be rendered on the mobile computing device's display when a cursor hovers over a link for the video.

FIG. 4B illustrates an embodiment method 450 for a mobile computing device to determine whether to obtain media by evaluating factors associated with accessing the media. As described above, the mobile computing device may manage media associated with links received in data (e.g., webpages, emails from friends including hyperlinks to interesting YouTube® videos, etc.). In particular, the mobile computing device may be configured to download media using the links. For example, when the mobile computing device has an Internet connection that is of sufficient quality that may enable efficient use of a WiFi transceiver without draining the battery below a tolerance threshold, the mobile computing device may download podcasts associated with links in an SMS text message.

In block 202, the mobile computing device may receive data that includes one or more links to media. In block 204, the mobile computing device may identify factors related to the media associated with the one or more links, such as by obtaining runtime information about a video. In block 206, the mobile computing device may evaluate battery-life-related factors relevant to the ability of the mobile computing device to use the media. In determination block 452, the mobile computing device may determine whether it may obtain the media. For example, based on the size of the media file, the type of cellular network connection (e.g., 3G, 4G LTE, etc.), and the amount of battery charge required to perform such a download, the mobile computing device may determine that an audio file indicated in an email may be downloaded. If the mobile computing device may not obtain the media (i.e., determination block 452=“No”), in optional block 404 the mobile computing device may present a warning message indicating the evaluation of battery-life-related factors, such as by rendering a message that states “Media can't be downloaded now.” If the media may be obtained (i.e., determination block 452=“Yes”), in block 454 the mobile computing device may automatically download the media associated with the one or more links based on the evaluation of battery-life-related factors. For example, the mobile computing device may automatically download a podcast audio file when the evaluation indicates that the battery charge is sufficient for downloading a file with the podcast's data complexity, file size, and the device's current Internet connectivity.

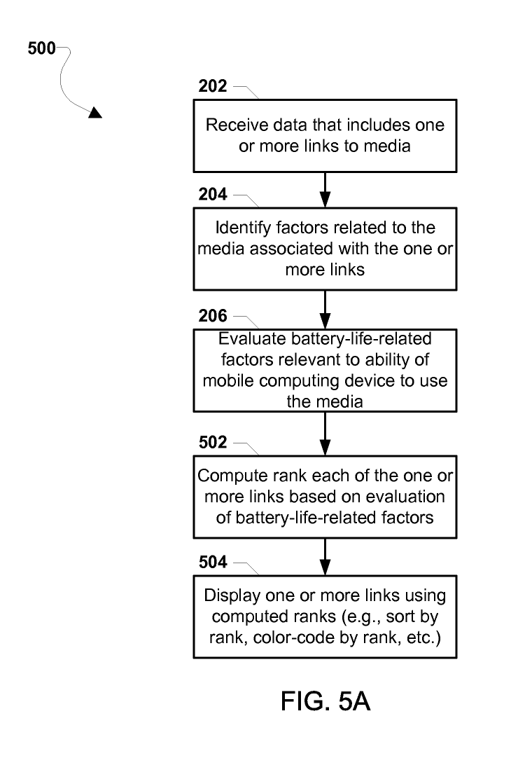

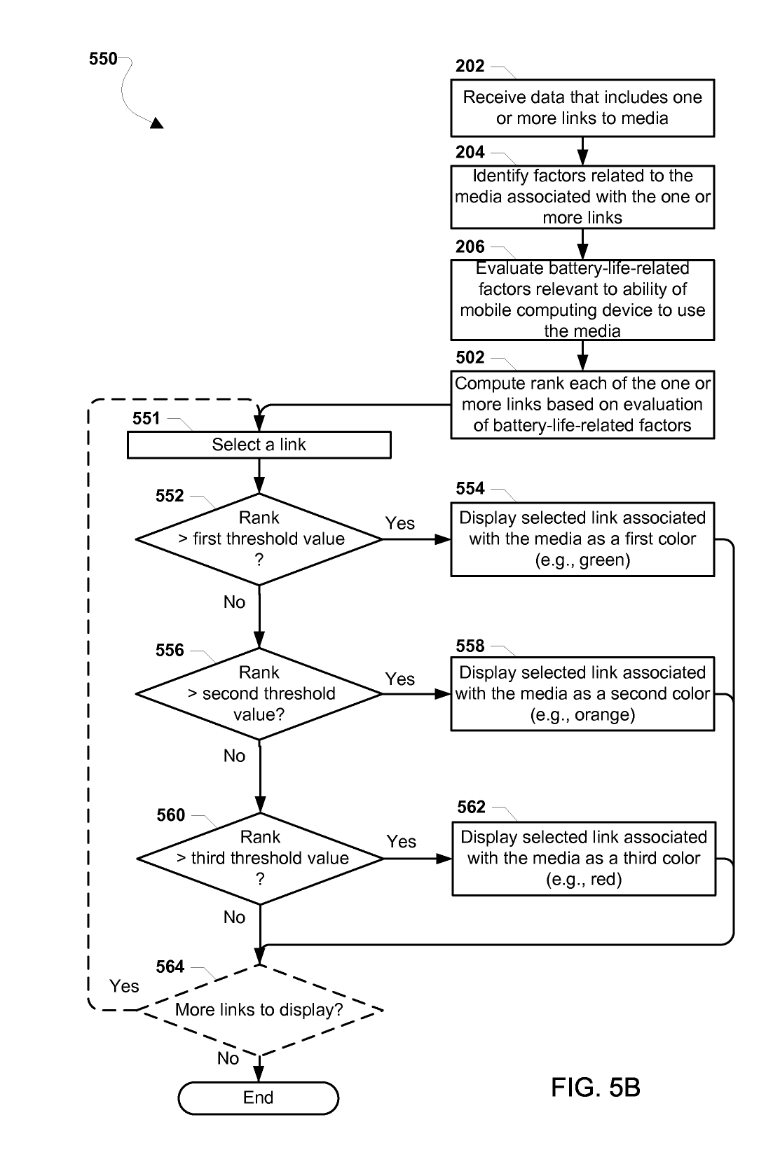

FIG. 5A illustrates an embodiment method 500 for a mobile computing device to compute ranks for prioritizing media by evaluating factors associated with accessing the media. The method 500 may be similar to the method 200 described above, except that the method 500 may include operations for displaying links to media based on ranks computed using the evaluations of battery-life-related factors, such as remaining battery charge and the amount of battery required to render/receive a particular media file. In block 202, the mobile computing device may receive data that includes one or more links to media. In block 204, the mobile computing device may identify factors related to the media associated with the one or more links, such as by obtaining runtime information about a video. In block 206, the mobile computing device may evaluate battery-life-related factors relevant to the ability of the mobile computing device to use the media.

In block 502, the mobile computing device may compute a rank for each of the one or more links based on the evaluation of battery-life-related factors. In particular, a rank may be a priority or a relative priority with respect to other media associated with links within the received data. For example, a computed rank may be a “high,” “medium,” or “low” priority rank that indicates with what urgency or importance the link should be used to access the associated media. In block 504, the mobile computing device may display the one or more links using the computed ranks. For example, the links may be displayed using a sorted order (e.g., highest priority first, most recommended first, etc.), a highlight, a color-coding (e.g., green, amber, red, etc.) and/or symbols (e.g., “!”, stop signs, “caution flags,” etc.). In an embodiment, the mobile computing device may display the links in particular positions or places on the device's display (e.g., at the top, side, overlaid on other graphical elements, etc.), in larger graphics (e.g., large text font, etc.), in smaller graphics (e.g., small text font, etc.), in a flashing format, in a blinking format, and using other graphical or visual manners to indicate importance as defined by the calculated ranks. For example, when the media associated with a link is computed to have a high priority or very important rank, the mobile computing device may display the link with bright, conspicuous lettering that is rendered before and/or apart from other text within the received data.

FIG. 5B illustrates an embodiment method 550 for a mobile computing device to present media links based on calculated ranks. The method 550 is similar to the method 500 described above, except that the method 550 includes operations for comparing computed ranks corresponding to media to predefined thresholds. In other words, the method 550 may be performed by the mobile computing device to display links with certain manners based on the computed ranks of the media. For example, links for high ranking media may be rendering as blinking, and links for low-ranking media may be rendered in a light color.

In block 202, the mobile computing device may receive data that includes one or more links to media. In block 204, the mobile computing device may identify factors related to the media associated with the one or more links, such as by obtaining runtime information about a video. In block 206, the mobile computing device may evaluate battery-life-related factors relevant to the ability of the mobile computing device to use the media. In block 502, the mobile computing device may compute a rank for each of the one or more links.

In block 551, the mobile computing device may select a link, such as one of the links associated with media indicated in an email from a friend. In determination block 552, the mobile computing device may determine whether the computed rank of the selected link is greater than a first threshold value. For example, the computed rank may be a number value that may be compared to threshold values associated with certain states or conditions predetermined by the mobile computing device and/or the user of the device. If the computed rank is greater than the first threshold value (i.e., determination block 552=“Yes”), in block 554 the mobile computing device may display the selected link associated with the media as a first color. For example, the selected link may be displayed in a green colored font, indicating a rank corresponding to a safe state (i.e., the media associated with the link may be immediately received and rendered given the current battery-life-related factors).

However, if the computed rank is not greater than the first threshold value (i.e., determination block 552=“No”), the mobile computing device may determine whether the computed rank of the selected link is greater than a second threshold value in determination block 556, such as a value associated with a second priority. If the computed rank is greater than the second threshold value (i.e., determination block 556=“Yes”), the mobile computing device may display the selected link associated with the media as a second color in block 558. For example, the selected link may be displayed in an amber colored font, indicating a rank corresponding to a moderate importance.

However, if the computed rank is not greater than the second threshold value (i.e., determination block 556=“No”), the mobile computing device may determine whether the computed rank for the selected link is greater than a third threshold value in determination block 560. If the computed rank is greater than the third threshold value (i.e., determination block 560=“Yes”), the mobile computing device may display the selected link associated with the media as a third color in block 562. For example, the selected link may be displayed in a red colored font, indicating a rank corresponding to a low importance that is not recommended for immediate viewing.

If the computed rank is not greater than the third threshold value (i.e., determination block 560=“No”), or if the operations in blocks 554, 558, or 562 have been performed, the mobile computing device may determine whether there are more links to display in optional determination block 564. In other words, the mobile computing device may display all links within the received data based on their individually computed ranks. If there are more links to display (i.e., optional determination block 564=“Yes”), the mobile computing device may continue with the operations in block 551 with regards to the next link. If there are no more links to display (i.e., optional determination block 564=“No”), the mobile computing device may end the process of managing media links.

FIGS. 6-7C illustrate embodiment methods for a mobile computing device to evaluate factors related to the ability of the mobile computing device to access media. As discussed above, embodiment mobile computing devices may be configured to analyze, evaluate, compare, and otherwise utilize various factors to determine how to manage media associated with links received within data/messages. Such mobile computing devices may prioritize, display, access, download, and use such media based on how the mobile computing device's battery life may be impacted by such actions (or the cost of accessing the media). In other words, mobile computing devices may prioritize, including determining whether to download and render videos, audio, and other media when the power, CPU, operational, and/or time costs of doing so would cause the mobile computing devices' battery and other functionalities to become unacceptably depleted or inaccessible. For example, when an evaluation of a link to a video of a conference talk indicates that streaming the video would a certain amount of battery charge, a smartphone may determine that the video is a low-priority item that should be avoided until the smartphone is plugged into a wall outlet. The operations in the methods illustrated in FIGS. 6-7C may be performed by a mobile computing device during the operations of block 206 described above with reference to FIG. 2. Additionally, although the following descriptions may describe the various methods illustrated in FIGS. 6-7C as being performed by a mobile computing device, those skilled in the art should appreciate that these operations may also be performed by other computing devices, such as a central server as described above.

The embodiment methods described below with reference to FIGS. 6-7C indicate various factors that may be evaluated when a mobile computing device is determining how and whether to process media associated with a link. The various factors are listed for the purposes of illustration and do not include all possible factors that a mobile computing device may evaluate in order to inform actions regarding media associated with links. Further, in the various embodiments, the factors may be weighed differently (e.g., signal strength is a more important metric for rank than server connection quality, etc.). In another embodiment, the mobile computing device may or may not evaluate particular factors based on various conditions or user preferences. For example, when the mobile computing device is plugged into a wall power outlet, the remaining battery life factor may not be relevant. In another embodiment, the mobile computing device may combine, condition, utilize rule sets and/or equations, and generate ratings, scores, or confidence assessments for the various evaluated factors. For example, a weak wireless signal strength may be associated with a low score or rank by the mobile computing device.

FIG. 6 illustrates an embodiment method 600 for evaluating factors related to a mobile computing device's ability to receive and render media associated with a link. As described above, the mobile computing device may perform the method 600 after performing the operations of block 204 described above with reference to FIG. 2. For example, the mobile computing device may perform a heuristics function that examines a plurality of battery-life-related information or factors to determine how to process media. In block 602, the mobile computing device may evaluate a remaining battery life of the device. In other words, the mobile computing device may evaluate the charge state of the device's battery. By polling the battery, or alternatively evaluating a bit or variable storing the current status of the battery, the mobile computing device may identify the available power for performing calculations, operating system operations, and various other routines. For example, the mobile computing device may evaluate the remaining battery life and determine the amount of time the device may continue to operate while performing typical actions.

In block 604, the mobile computing device may evaluate factors affecting battery life needed to receive media. As described below, such as with reference to FIG. 7A, various factors may be examined to determine the impact on the battery life that may be incurred when the media is downloaded, streamed, requested, and otherwise received. For example, the mobile computing device may evaluate the amount of battery life that may be expended to exchange communications with a web server and download an audio file of a certain size that is hosted by the web server. In block 606, the mobile computing device may evaluate factors affecting battery life needed to render the media. As described below, such as with reference to FIG. 7B, various factors may be examined to determine the impact on the battery life that may be incurred when downloaded (or received) media is rendered. For example, the mobile computing device may evaluate the amount of battery life that may be expended to display visuals and emit audio corresponding to a video of a certain runtime, resolution, and technology requirements (e.g., codec).

In optional block 608, the mobile computing device may generate operating instructions, routines, and/or scripts based on the evaluations of battery-life-related factors. Such generated instructions may include software commands the mobile computing device may execute to operate in accordance with the evaluation of battery-life-related factors. For example, when performed, the instructions may cause the mobile computing device to display links in particular manners (e.g., colors, sorting, etc.). In another embodiment, the instructions may cause the mobile computing device to operate in particular modes, states, or configurations. For example, the mobile computing device may be configured to operate in a power saving mode when the evaluations of battery-life-related factors indicate that a particular video may be best viewed in after a period has elapsed (e.g., a period of time needed for the mobile computing device to enter an area with a stronger cellular network reception).

In optional block 610, the mobile computing device may generate recommendation messages for display based on the evaluations of battery-life-related factors. For example, the recommendation messages may be based on the evaluation of the remaining battery life (e.g., “You shouldn't watch any videos now, as your battery is almost dead!”). The mobile computing device may continue with the operations of block 208 described above with reference to FIG. 2. In other words, the mobile computing device may process the media based on the evaluations of battery-life-related factors.

FIG. 7A illustrates an embodiment method 700 for evaluating factors related to a mobile computing device's ability to receive and render media associated with a link. The method 700 is similar to the method 600 described above, except that the method 700 may include operations specific to particular factors that may affect battery life when receiving media. As described above, the mobile computing device may perform the method 700 after performing the operations of block 204 described above with reference to FIG. 2.

In block 602, the mobile computing device may evaluate a remaining battery life of the device. In block 702, the mobile computing device may evaluate a signal strength of the current device technology. For example, the mobile computing device may identify the current stability, strength, and reliability of the cellular network, local area network, or other long-range wireless communication link the mobile computing device may use to download or access media from remote sources. In block 704, the mobile computing device may evaluate a server connection quality/speed. For example, based on previous communications (e.g., a download history, information from recent queries, etc.), the mobile computing device may evaluate the speed of typical transmissions with the data server that hosts the media. The mobile computing device may use the server connection quality/speed evaluations as an indication of how much energy may be needed to request and retrieve the media.

In block 706, the mobile computing device may evaluate the size of the media. For example, based on metadata information, the mobile computing device may determine the number of bits, bytes, megabytes, etc. that may be downloaded from a data server, as well as well how much time and/or battery power may be needed for receiving such a file size. In block 708, the mobile computing device may evaluate the server availability/response time. For example, the mobile computing device may identify how long a data server takes to respond or how many requests are needed to receive files from the server. This may be a reflection of the popularity or traffic drawing from the server. In block 710, the mobile computing device may evaluate an estimated download time for the media. In block 606, the mobile computing device may evaluate factors affecting battery life needed to render the media. The mobile computing device may continue with the operations of block 208 described above with reference to FIG. 2.

FIG. 7B illustrates an embodiment method 720 for evaluating factors related to a mobile computing device's ability to receive and render media associated with a link. The method 720 is similar to the method 600 described above, except that the method 720 may include operations specific to particular factors that may affect battery life when rendering media. As described above, the mobile computing device may perform the method 720 after performing the operations of block 204 described above with reference to FIG. 2.

In block 602, the mobile computing device may evaluate a remaining battery life of the device. In block 604, the mobile computing device may evaluate factors affecting battery life needed to receive media. In block 722, the mobile computing device may evaluate the type of media, such as video, audio, Flash animations, slide shows, and other presentations of information. In block 724, the mobile computing device may evaluate the complexity of the media data. For example, the complexity may be high for multi-media documents that include text, audio, and video. As another example, the complexity may or may not be high dependent upon characteristics of the media, such as the compression algorithm utilized to generate the media file for streaming purposes. In an embodiment, evaluating the complexity of the media data may include evaluating the decoding rate as well as the buffering requirements (e.g., time or buffer size required) for the media. In block 726, the mobile computing device may evaluate the runtime of the media (e.g., the number of minutes of footage included, the number of cycles/seconds required to render streamed audio/video, etc.). In block 728, the mobile computing device may evaluate the technology utilized by the media, such as the codec, encoding, or other processing algorithms associated with the media. In particular, different software services or applications may be required to render certain media, and likewise may require varying degrees of battery life. As described above, the mobile computing device may perform the method 720 after performing the operations of block 204 described above with reference to FIG. 2.

FIG. 7C illustrates an embodiment method 730 for evaluating factors related to a mobile computing device's ability to receive and render media associated with a link. The method 730 is similar to the method 600 described above, except that the method 730 may include operations to evaluate other factors the mobile computing device may utilize in determining how and/or whether to process the media. For example, the mobile computing device may evaluate data stored on the device that represents the user's preferences about data plan use in combination with the evaluation of signal strength to determine whether to rank a link to an audio file as a higher priority during a low-battery operating state. As described above, the mobile computing device may perform the method 720 after performing the operations of block 204 described above with reference to FIG. 2.

In block 602, the mobile computing device may evaluate a remaining battery life of the device. In block 604, the mobile computing device may evaluate factors affecting battery life needed to receive media. In block 606, the mobile computing device may evaluate factors affecting battery life needed to render the media. In block 732, the mobile computing device may evaluate data plan limitations. For example, the mobile computing device may compare the size of a media file with stored data indicating the remaining data that may be downloaded without the user of the device incurring an additional charge from a data carrier. In an embodiment, the mobile computing device may identify when the data plan does not have enough remaining use to allow the user to access the media without incurring a penalty fee. In other words, the mobile computing device may identify a monetary “charge” for downloading the media given various conditions with respect to the data plan. In block 734, the mobile computing device may evaluate data from sensors within the device, such as GPS sensors, accelerometers, and gyroscopes. Sensor data may be used in decision matrices such that battery drain considerations (e.g., the amount of data to download, the availability of a data server, etc.) may be combined with location of the device. For example, using GPS coordinates of the device's current location, the mobile computing device may determine that although there is adequate battery life to access a streaming audio file, however the because the user is at work, the media may be a lower priority or even disallowed entirely (e.g., NSFW).

In block 736, the mobile computing device may evaluate user availability information, such as stored calendar data. The mobile computing device may compare the free moments in the user's daily schedule, such as the time in between business meetings, to the duration of a media file to identify whether the user should start streaming now or later. In block 738, the mobile computing device may evaluate user preferences/established operating parameters. For example, the mobile computing device may utilize user profile data (e.g., previous locations, known travel patterns, data usage trends, preferred media types, etc.), as well as established rule sets for downloading, sorting/ranking hyperlinks, and otherwise managing links to media data. In an embodiment, the evaluation may include evaluating preferences of software for rendering media, preferred data sources/providers, and other rules that may impact how media is received and/or rendered. As described above, the mobile computing device may perform the method 730 after performing the operations of block 204 described above with reference to FIG. 2.

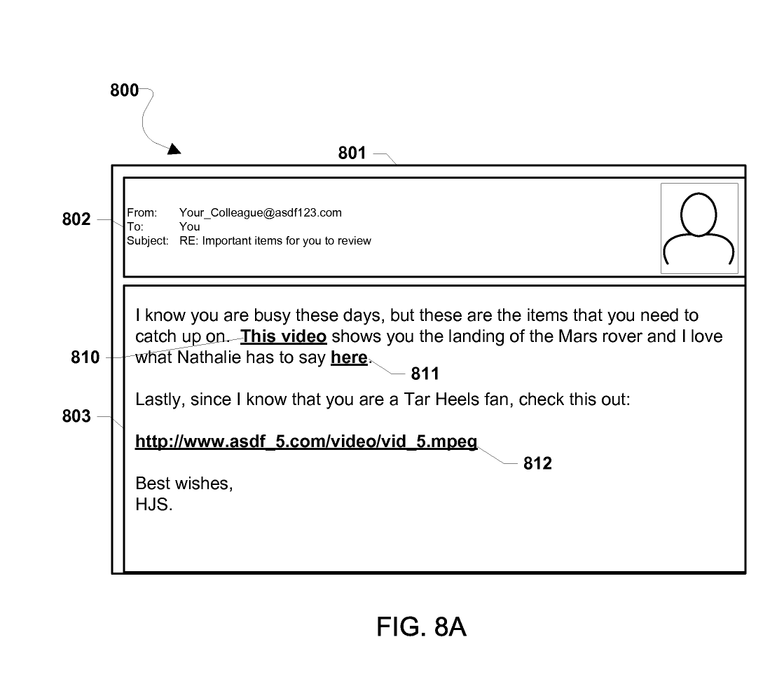

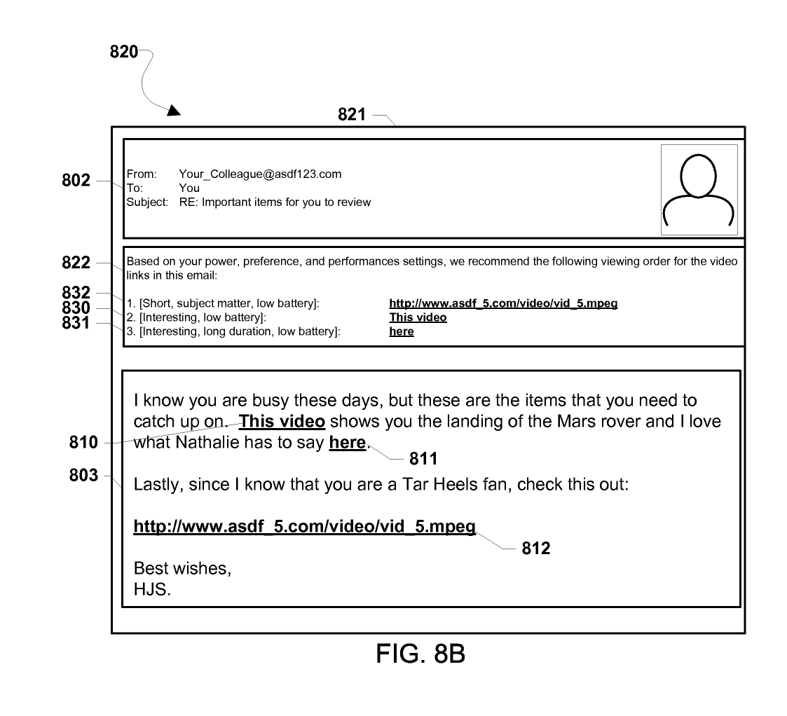

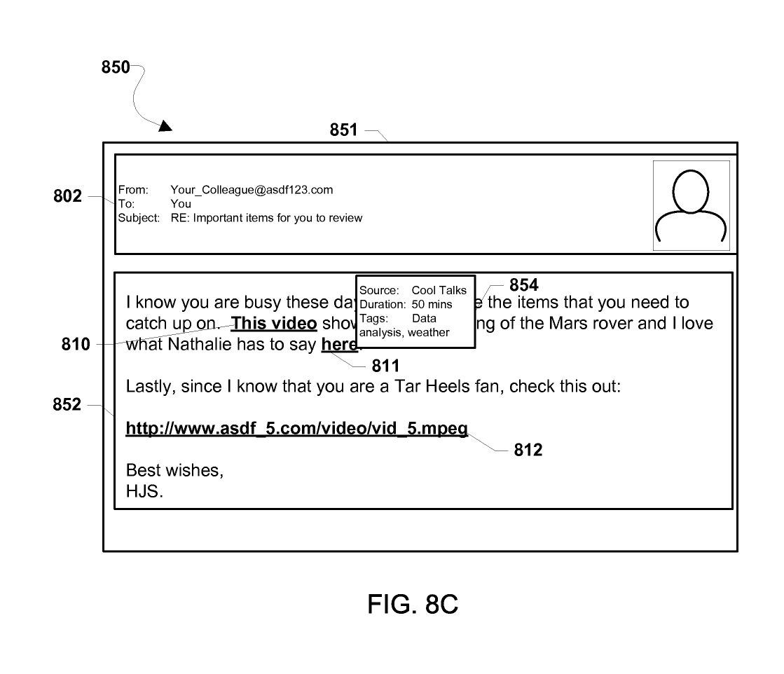

For the purposes of illustration: FIGS. 8A-8C show diagrams 800, 820, 850 of embodiment displays 801, 821, 851 of an email that includes links to media that may be accessed by a mobile computing device. FIG. 8A illustrates a first display 801 of the email received by the mobile computing device. The first display 801 may include a header section 802 that includes addresses and other informative information, as well as a body section 803 that includes the contents of the email. The email may include text with embedded links 810, 811, 812 to various media. For example, a first link 810 may be represented by the words “This video”, a second link 811 may be represented by the word “here,” and a third link 812 may be represented by a conventional URL. When displayed by the mobile computing device, the first display 801 of the email may not include any indications, warnings, or other information describing how the media associated with each link 810, 811, 812 may affect the battery life of the mobile computing device.

However, in FIG. 8B, a second display 821 of the email includes additional information based on evaluations of factors related to the battery life of the mobile computing device and presents the links 810-812 in a recommended order for receiving and rendering the associated media. The second display 821 may include a recommendation section 822 that includes information about the individual links 810, 811, 812 included in the body section 803 of the email. In particular, the recommendation section 822 may include ranked descriptions of the links 810, 811, 812. For example, the first recommendation 832 may correspond to the third link 812 and may include a message that indicates the third link 812 is short, pertains to a subject matter relevant to the mobile computing device (e.g., listed in the user's preferred subject matter), and may be received and rendered easiest when the device is in a low battery state. A second recommendation 830 may correspond to the first link 810 and may include a message that indicates the media associated with the first link 810 is interesting to the user, and may be received and rendered less easily than the media associated with the first recommendation 832. A third recommendation 831 may correspond to the second link 811 and may include a message that indicates the media associated with the second link 811 is interesting to the user, but has a long duration and thus may be received and rendered less easily than any other media within the email.

FIG. 8C illustrates a third display 851 of the email. Instead of presenting additional information to the user via a recommendation section 822 as shown above with reference to FIG. 8B, the third display 851 may render a body section 852 that includes a pop-up box 854 with information related to the media associated with the second link 811. For example, the pop-up box 854 may include the source of the media, the duration of the media, and any tags associated with the link and/or media (e.g., a “NSFW” tag). In an embodiment, the pop-up box 854 may be rendered by the mobile computing device when a cursor or finger is placed over or selects the second link 811.

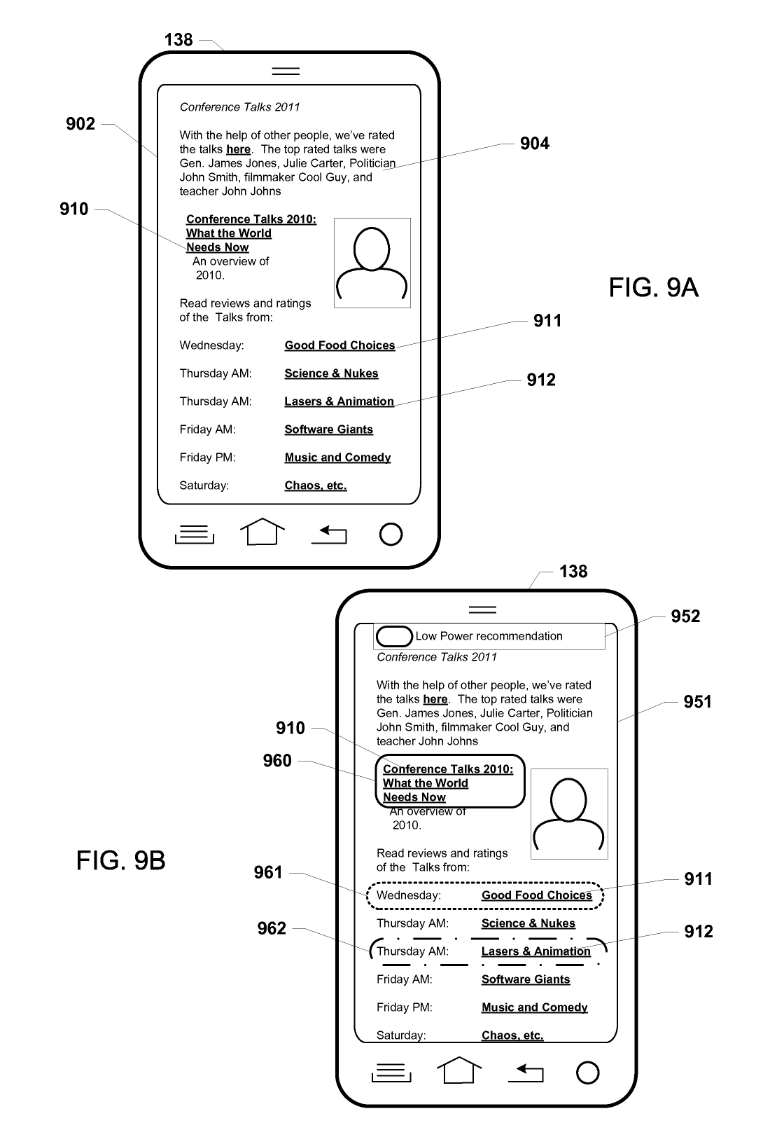

For the further purposes of illustration: FIGS. 9A-9B show diagrams of embodiment displays 902, 951 on a mobile computing device 138 configured to render links to media. As discussed above, a mobile computing device 138 may receive and display various types of messages or data, such as SMS text messages from a family member, a webpage with HTML code, an email from a work buddy, and chat messages within proprietary applications. FIG. 9A illustrates a display 902 presenting data in a typical manner. The data (or message) may be a webpage that includes various hyperlinks and content (e.g., pictures, static descriptions, etc.) related to talks, events, and discussions of a conference (e.g., TED Conference). In an embodiment, the data may be accessed via a browser application on the mobile computing device 138. The data may include a section of regular text 904, as well as various interactive elements, including a first hyperlink 910 to an overview article, a second hyperlink 911 to a “Good Food Choices” discussion, and a third hyperlink 912 to a “Lasers & Animation” discussion. The display 902 may present such information in a typical manner and may not provide information corresponding to battery-life-related factors and/or power or performance warnings/indications associated with the hyperlinks 910-912.

However, FIG. 9B illustrates a display 951 presenting the data (e.g., webpage) on the mobile computing device 138 when configured to execute various embodiment methods. Unlike the display 902 of FIG. 9A, the display 951 may include a header section 952 that indicates media associated with links within the webpage may be recommended for accessing when the mobile computing device 138 has low battery power. In other words, the media associated with links within the webpage may be indicated as being the better or worse for viewing given the current battery life, wireless signal strength, and other factors of the mobile computing device 138. In particular, a first indicator 960 may indicate that the first hyperlink 910 is currently highly recommended (i.e., the media associated with the first hyperlink 910 may be best for receiving and rendering with a low amount of battery power). In various embodiments, the first indicator 960 may be a pattern, highlight, a certain color-coding (e.g., green), or other formatting that the user may associate with a strong/high recommendation (i.e., best for viewing now).

A second indicator 961 may be associated with the second hyperlink 911, and may indicate that the media associated with the second hyperlink 911 may require more battery power than is currently recommended. For example, the second indicator 961 may be a certain pattern, highlight, color-coding (e.g., red), or other formatting that the user may associate with a weak/low recommendation (i.e., worst for viewing now).

A third indicator 962 may be associated with the third hyperlink 912, and may indicate that the media associated with the third hyperlink 912 may require more battery power than the media associated with the first hyperlink 910 but less power than the media associated with the second hyperlink 911. For example, the third indicator 962 may be a certain pattern, highlight, color-coding (e.g., amber/yellow), or other formatting that the user may associate with a medium recommendation (i.e., not best and not worst for viewing now).

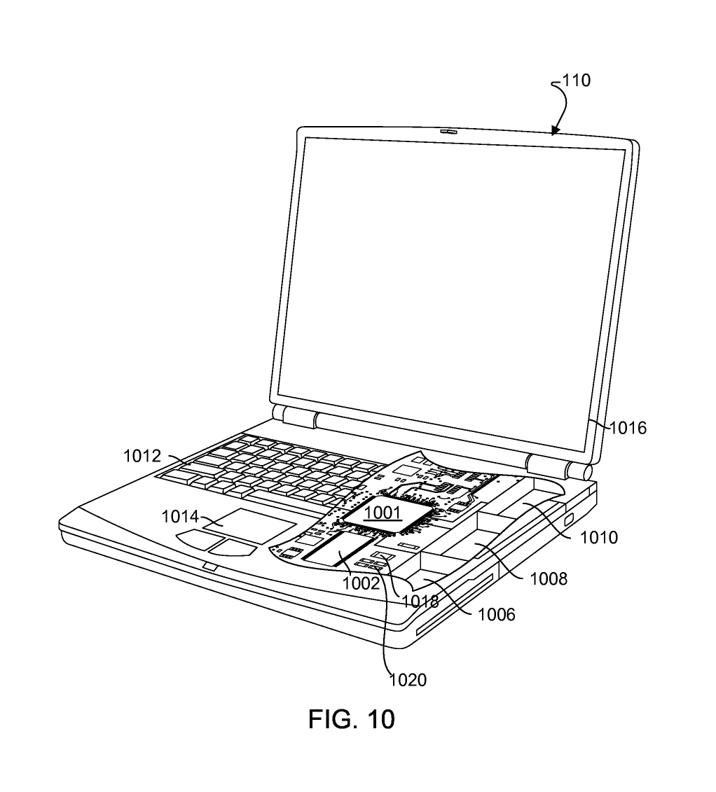

Various forms of computing devices, including personal computers and laptop computers, may be used to implementing the various embodiments. Such mobile computing devices typically include the components illustrated in FIG. 10 which illustrates an example laptop mobile computing device 110. Many laptop computers include a touch pad 1014 that serves as the computer's pointing device, and thus may receive drag, scroll, and flick gestures similar to those implemented on mobile computing devices equipped with a touch screen display and described above. Such a laptop mobile computing device 110 generally includes a processor 1001 coupled to volatile internal memory 1002 and a large capacity nonvolatile memory, such as a disk drive 1006. The laptop mobile computing device 110 may also include a compact disc (CD) and/or DVD drive 1008 coupled to the processor 1001. The laptop mobile computing device 110 may also include a number of connector ports 1010 coupled to the processor 1001 for establishing data connections or receiving external memory devices, such as a network connection circuit for coupling the processor 1001 to a network. The laptop mobile computing device 110 may have one or more short-range radio signal transceivers 1018 (e.g., Peanut®, Bluetooth®, Zigbee®, RF radio) and antennas 1020 for sending and receiving wireless signals. In a laptop or notebook configuration, the computer housing includes the touch pad 1014, the keyboard 1012, and the display 1016 all coupled to the processor 1001. Other configurations of the laptop mobile computing device may include a computer mouse or trackball coupled to the processor (e.g., via a USB input) as are well known, which may also be used in conjunction with the various aspects.

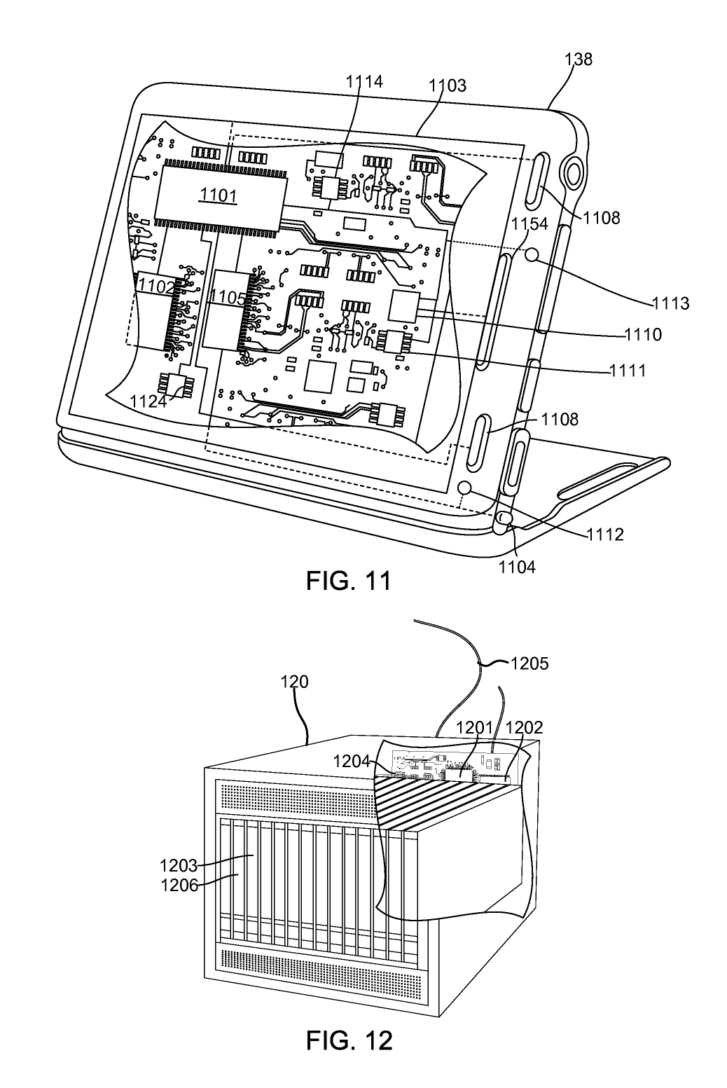

FIG. 11 is a system block diagram of a smartphone-type mobile computing device 138 suitable for use with various embodiments. The mobile computing device 138 may include a processor 1101 coupled to internal memory 1102, a display 1103, and to a speaker 1154. Additionally, the mobile computing device 138 may include an antenna 1104 for sending and receiving electromagnetic radiation that may be connected to a wireless data link and/or long-range wireless signal transceiver 1105, such as a cellular network or WiFi radio, coupled to the processor 1101 and capable of communicating over a wide area wireless communication network. Mobile computing devices 138 may include a separate short-range radio transceiver 1124 capable of communicating or pairing with other mobile computing devices. Mobile computing devices 138 typically may also include menu selection buttons or rocker switches 1108 for receiving user inputs. Additionally, the mobile computing device 138 may include an accelerometer 1110, a gyroscope 1111, and a GPS receiver chip 1114 coupled to the processor 1101. In an embodiment, the mobile computing device 138 may also include a microphone 1112 and a camera 1113 coupled to the processor 1101.

The various embodiments may be implemented on any of a variety of commercially available server devices, such as the server 120 illustrated in FIG. 12. Such a server 120 typically includes a processor 1201 coupled to volatile memory 1202 and a large capacity nonvolatile memory, such as a disk drive 1203. The server 120 may also include a floppy disc drive, compact disc (CD) or DVD disc drive 1206 coupled to the processor 1201. The server 120 may also include network access ports 1204 coupled to the processor 1201 for establishing data connections with a network 1205, such as a local area network coupled to other broadcast system computers and servers.

The processors 1001, 1101, and 1201 may be any programmable microprocessor, microcomputer or multiple processor chip or chips that can be configured by software instructions (applications) to perform a variety of functions, including the functions of the various aspects described above. In the various devices, multiple processors may be provided, such as one processor dedicated to wireless communication functions and one processor dedicated to running other applications. Typically, software applications may be stored in the internal memory 1002, 1102, and 1202 before they are accessed and loaded into the processors 1001, 1101, and 1201. The processors 1001, 1101, and 1201 may include internal memory sufficient to store the application software instructions. In many devices the internal memory may be a volatile or nonvolatile memory, such as flash memory, or a mixture of both. For the purposes of this description, a general reference to memory refers to memory accessible by the processors 1001, 1101, and 1201 including internal memory or removable memory plugged into the various devices and memory within the processors 1001, 1101, and 1201.

The foregoing method descriptions and the process flow diagrams are provided merely as illustrative examples and are not intended to require or imply that the steps of the various embodiments must be performed in the order presented. As will be appreciated by one of skill in the art the order of steps in the foregoing embodiments may be performed in any order. Words such as “thereafter,” “then,” “next,” etc. are not intended to limit the order of the steps; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some steps or methods may be performed by circuitry that is specific to a given function.

In one or more exemplary embodiments, the functions described may be implemented in hardware, software, firmware, or any combination thereof. If implemented in software, the functions may be stored on or transmitted over as one or more instructions or code on a computer-readable medium. The steps of a method or algorithm disclosed herein may be embodied in a processor-executable software module that may reside on a tangible, non-transitory computer-readable storage medium. Tangible, non-transitory computer-readable storage media may be any available media that may be accessed by a computer. By way of example, and not limitation, such non-transitory computer-readable media may comprise RAM, ROM, EEPROM, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of non-transitory computer-readable media. Additionally, the operations of a method or algorithm may reside as one or any combination or set of codes and/or instructions on a tangible, non-transitory machine readable medium and/or computer-readable medium that may be incorporated into a computer program product.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

What is claimed is:

1. A method, performed by one or more computing devices, for presenting information to a user about accessing media, the method comprising:
evaluating battery-life-related factors relevant to an ability of a mobile computing device to use the media; and
determining, based on the evaluation of battery-life-related factors, at least one of (i) whether to display or hide a first set of one or more links associated with the media, (ii) how to display a second set of one or more links associated with the media, or (iii) whether to automatically download the media.

2. The method of claim 1, wherein determining, based on the evaluation of battery-life-related factors, at least one of (i) whether to display or hide a first set of one or more links associated with the media, (ii) how to display a second set one or more links associated with the media, or (iii) whether to automatically download the media comprises:
determining, based on the evaluation of battery-life-related factors, whether to display or hide the first set of one or more links associated with the media; and
wherein the method further comprises, by the mobile computing device, displaying or hiding the first set of one or more links associated with the media according to the determination.

3. The method of claim 1, wherein determining, based on the evaluation of battery-life-related factors, at least one of (i) whether to display or hide a first set of one or more links associated with the media, (ii) how to display a second set one or more links associated with the media, or (iii) whether to automatically download the media comprises:
determining, based on the evaluation of battery-life-related factors, whether to automatically download the media; and
wherein the method further comprises, by the mobile computing device, automatically downloading the media according to the determination.

4. The method of claim 1, wherein determining, based on the evaluation of battery-life-related factors, at least one of (i) whether to display or hide a first set of one or more links associated with the media, (ii) how to display a second set one or more links associated with the media, or (iii) whether to automatically download the media comprises:
determining, based on the evaluation of battery-life-related factors, how to display the second set of one or more links associated with the media; and
wherein the method further comprises, by the mobile computing device, displaying the second set of one or more links associated with the media according to the determination.

5. The method of claim 4, wherein determining, based on the evaluation of battery-life-related factors, how to display the second set of one or more links associated with the media comprises:
determining, based on the evaluation of battery-life-related factors, at least one of (a) how to sort the second set of one or more links, (b) how to color-code the second set of one or more links, (c) how to highlight the second set of one or more links, (d) how to position the second set of one or more links on a display of the mobile computing device, (e) how to size text and/or graphics associated with the second set of one or more links, or (f) how to format the second set of one or more links.

6. The method of claim 1, wherein evaluating battery-life-related factors relevant to an ability of a mobile computing device to use the media comprises:
receiving a document that includes:
the first or the second set of one or more links associated with the media; and
metadata describing at least one of the battery-life-related factors for the media; and
evaluating the metadata describing at least one of the battery-life-related factors for the media.

7. The method of claim 1, wherein the battery-life-related factors relevant to the ability of the mobile computing device to use the media include a battery charge state of the mobile computing device and at least one of (i) one or more factors affecting an amount of battery life needed to receive the media or (ii) one or more factors affecting an amount of battery life needed to render the media.

8. The method of claim 7, wherein the one or more factors affecting the amount of battery life needed to receive the media include at least one of a strength of a wireless signal to be used to receive the media, a quality of a connection to a server that hosts the media, a speed of the connection to the server that hosts the media, an availability of the server that hosts the media, a response time of the server that hosts the media, a size of the media, or an estimated download time for the media.

9. The method of claim 7, wherein the one or more factors affecting the amount of battery life needed to render the media include at least one of a type of the media, a complexity of the media, a runtime of the media, a technology utilized by the media, or a size of the media.

10. The method of claim 7, wherein evaluating battery-life-related factors relevant to an ability of a mobile computing device to use the media comprises:
evaluating the battery-life-related factors in combination with at least one of data plan limitations, sensor data, user availability information, or user preferences, wherein sensor data includes at least one of GPS fix data and accelerometer data, and wherein user availability information includes stored calendar data.

11. The method of claim 1, further comprising based on the evaluation of battery-life-related factors, determining whether to display a warning when the user selects one or more links associated with the media.

12. The method of claim 1, wherein:
the evaluation of the battery-life-related factors is performed by a server;
the method further comprises, by the mobile computing device, receiving information describing the evaluation of the battery-life-related factors from the server; and
the determination based on the evaluation of battery-life-related factors is performed by the mobile computing device.

13. A mobile computing device comprising:
a memory; and
a processor coupled to the memory, wherein the processor is configured with processor-executable instructions to perform a method comprising:
evaluating battery-life-related factors relevant to an ability of the mobile computing device to use the media; and
determining, based on the evaluation of battery-life-related factors, at least one of (i) whether to display or hide a first set of one or more links associated with the media, (ii) how to display a second set of one or more links associated with the media, or (iii) whether to automatically download the media.

14. A method performed by a server, the method comprising:
evaluating one or more battery-life-related factors relevant to an ability of a mobile computing device to use the media; and
transmitting, to the mobile computing device, information describing the evaluation of one or more battery-life-related factors, the mobile computing device configured to use the information to determine at least one of (i) whether to display or hide a first set of one or more links associated with the media, (ii) how to display a second set of one or more links associated with the media, or (iii) whether to automatically download the media.

15. The method of claim 14, wherein the one or more battery-life-related factors relevant to the ability of the mobile computing device to use the media include at least one of (i) one or more factors affecting an amount of battery life needed to receive the media or (ii) one or more factors affecting an amount of battery life needed to render the media.

16. The method of claim 15, wherein the one or more factors affecting the amount of battery life needed to receive the media include at least one of a strength of a wireless signal to be used to receive the media, a quality of a connection to a server that hosts the media, or a speed of the connection to the server that hosts the media, an availability of the server that hosts the media, a response time of the server that hosts the media, a size of the media, or an estimated download time for the media.

17. The method of claim 15, wherein the one or more factors affecting the amount of battery life needed to render the media include at least one of a type of the media, a complexity of the media, a runtime of the media, a technology utilized by the media, or a size of the media.
